(19) United States
(12) Patent Application Publication
(10) Pub. No.: US 2026/0342796 A1
(43) Pub. Date: Oct. 29, 2026

(54) SERVER, METHOD, AND NON-TRANSITORY COMPUTER READABLE STORAGE MEDIUM FOR RESTRICTING ABNORMAL ACCESS

(71) Applicant: NC CORPORATION, Seongnam-si (KR)

(72) Inventor: Sijin KIM, Seongnam-si (KR)

(73) Assignee: NC CORPORATION, Seongnam-si (KR)

(21) Appl. No.: 19/639,614

(22) Filed: Apr. 6, 2026

(30) Foreign Application Priority Data
Apr. 23, 2025 (KR) 10-2025-0053136

(51) Int. Cl. H04L 9/40; G06F 8/61

(52) U.S. Cl. CPC H04L 63/101; G06F 8/61; H04L 63/0876

(57) ABSTRACT

A server includes communication circuitry, memory comprising one or more storage media storing instructions, and at least one processor comprising processing circuitry. These instructions, when executed by the at least one processor individually or collectively, cause the server to identify installation information related to a software application installed in a first electronic device, identify the installation information related to the software application installed in a second electronic device, identify, based on identifying the installation information of the second electronic device corresponding to the installation information of the first electronic device, a first network address assigned to the first electronic device and a second network address assigned to the second electronic device, and store, based on identifying that the first network address is different from the second network address, first account information of the first electronic device and second account information of the second electronic device in the server.

### CROSS-REFERENCE TO RELATED APPLICATIONS

This application is based on and claims priority under 35 U.S.C. § 119(a), of a Korean patent application number No. 10-2025-0053136, filed on Apr. 23, 2025, in the Ministry of Intellectual Property, the disclosure of which is incorporated by reference herein in its entirety.

### BACKGROUND

### 1. Field

The disclosure relates to a server, a method, and a non-transitory computer readable storage medium for restricting abnormal access.

### 2. Description of Related Art

A server may identify information connected to the server. For example, the server may identify information used to connect from an electronic device to the server. For example, the server may identify account information used to connect from the electronic device to the server. The server may be connected to the electronic device through a network. The server may identify, together with the account information used to connect from the electronic device to the server, an address of the network between the electronic device and the server. The server may store the account information and the network address in the server.

The above-described information may be provided as a related art for the purpose of helping understanding of the present disclosure. No argument or decision is made as to whether any of the above description may be applied as a prior art related to the present disclosure.

### SUMMARY

Aspects of the disclosure are to address at least the above-mentioned problems and/or disadvantages and to provide at least the advantages described below. Accordingly, an aspect of the disclosure is to provide a server for restricting abnormal access and a method thereof.

Additional aspects will be set forth in part in the description which follows and, in part, will be apparent from the description, or may be learned by practice of the presented embodiments

In accordance with an aspect of the disclosure, a server is provided. The server may comprise communication circuitry. The server may comprise memory comprising one or more storage media storing instructions. The server may comprise at least one processor comprising processing circuitry. The instructions, when executed by the at least one processor individually or collectively, may cause the server to identify installation information related to first account information among a set of account information accessed to a service. The instructions, when executed by the at least one processor individually or collectively, may cause the server to identify, among the set of account information, second account information having the same installation information as the installation information related to the first account information. The instructions, when executed by the at least one processor individually or collectively, may cause the server to identify a first network address related to the first account information and a second network address related to the second account information. The instructions, when executed by the at least one processor individually or collectively, may cause the server to, based on identifying that the first network address and the second network address are different, determine the first account information and the second account information as a blacklist for restricting access to the service.

In accordance with an aspect of the disclosure, a method performed by a server is provided. The method may comprise identifying installation information related to first account information among a set of account information accessed to a service. The method may comprise identifying, among the set of account information, second account information having the same installation information as the installation information related to the first account information. The method may comprise identifying a first network address related to the first account information and a second network address related to the second account information. The method may comprise, based on identifying that the first network address and the second network address are different, determining the first account information and the second account information as a blacklist for restricting access to the service.

In accordance with another aspect of the disclosure, one or more non-transitory computer-readable storage media is provided. The non-transitory computer-readable storage medium, when executed by a server comprising communication circuitry, may store one or more programs including instructions that cause the server to identify installation information related to first account information among a set of account information accessed to a service. The non-transitory computer-readable storage medium, when executed by the server, may store one or more programs including instructions that cause the server to identify, among the set of account information, second account information having the same installation information as the installation information related to the first account information. The non-transitory computer-readable storage medium, when executed by the server, may store one or more programs including instructions that cause the server to identify a first network address related to the first account information and a second network address related to the second account information. The non-transitory computer-readable storage medium, when executed by the server, may store one or more programs including instructions that cause the server to, based on identifying that the first network address and the second network address are different, determine the first account information and the second account information as a blacklist for restricting access to the service.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 illustrates an example of a server and one or more user terminals that are interconnected for a game service according to an embodiment of the disclosure;

FIGS. 2A, 2B, and 2C, illustrate an exemplary case of providing a user experience related to a game by using a plurality of user terminals according to an embodiment of the disclosure;

FIG. 3A illustrates a simplified block diagram of a server and a plurality of electronic devices in a network environment according to an embodiment of the disclosure;

FIG. 3B illustrates a situation in which a software application installed in an electronic device and installation information related to the software application are copied to a plurality of electronic devices according to an embodiment of the disclosure;

FIG. 4 is a flowchart illustrating an operation of a server determining account information as a blacklist based on installation information and a network address related to the account information according to an embodiment of the disclosure;

FIGS. 5A and 5B illustrate examples of installation information and network addresses of a plurality of electronic devices in a situation in which the plurality of electronic devices are accessed to a server and a service through a plurality of network addresses according to an embodiment of the disclosure;

FIGS. 6A and 6B illustrate examples of installation information and a network address of a plurality of electronic devices in a situation in which the plurality of electronic devices are accessed to a server and a service through one network address according to an embodiment of the disclosure;

FIG. 7 illustrates a graph indicating the number of accounts accessed to a service over time according to an embodiment of the disclosure;

FIG. 8 is a flowchart illustrating an operation of a server determining account information as a blacklist based on installation information and a network address. related to the account information according to an embodiment of the disclosure;

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

An electronic device according to various embodiments disclosed in the present document may be a device in various forms. The electronic device may include, for example, a portable communication device (e.g., a smartphone), a computer device, and a portable multimedia device. The electronic device according to an embodiment of the present document is not limited to the above-described devices.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

Various embodiments of the present disclosure and terms used therein are not intended to limit the technical features described in the present disclosure to specific embodiments, and may not be intended to limit the scope of the present disclosure. A singular expression may include a plural expression unless the context clearly indicates otherwise. Terms used herein, including technical or scientific terms, may have the same meanings as those generally understood by a person having ordinary skill in the art described in the present disclosure. Among the terms used in the present disclosure, terms defined in a general dictionary may be interpreted as having the same or similar meanings as those in the context of the related art, and unless explicitly defined in the present disclosure, they are not interpreted in an idealistic or overly formal sense. In some cases, even terms defined in the present disclosure may not be interpreted to exclude embodiments of the present disclosure.

In addition, in the present disclosure, each of phrases such as “A or B,” “at least one of A and B,” “at least one of A or B,” “A, B, or C,” “at least one of A, B, and C,” and “at least one of A, B, or C” may include any one of items listed together in the corresponding phrase among those phrases, or all possible combinations thereof. Terms such as “first,” “second,” or “firstly” or “secondly” may be used merely to distinguish a corresponding component from another corresponding component, and do not limit the corresponding components in another aspect (e.g., importance or order).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

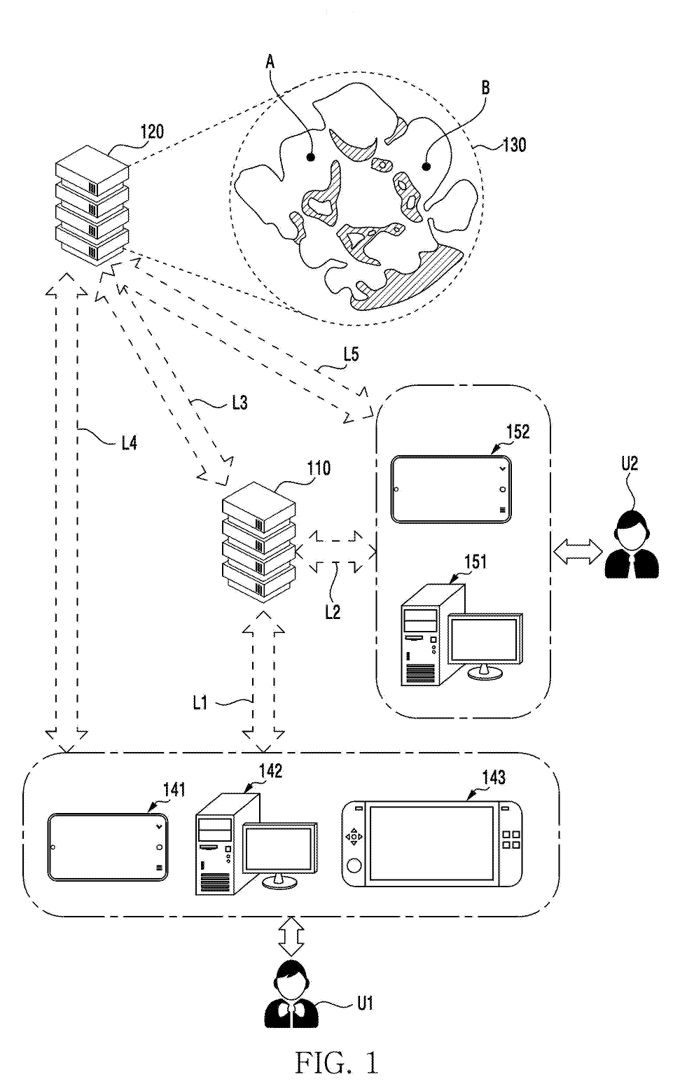

FIG. 1 illustrates an example of a server (e.g., servers 110 and 120) and one or more user terminals (e.g., user terminals 141, 142, 143, 151, and 152) that are interconnected for providing a game service.

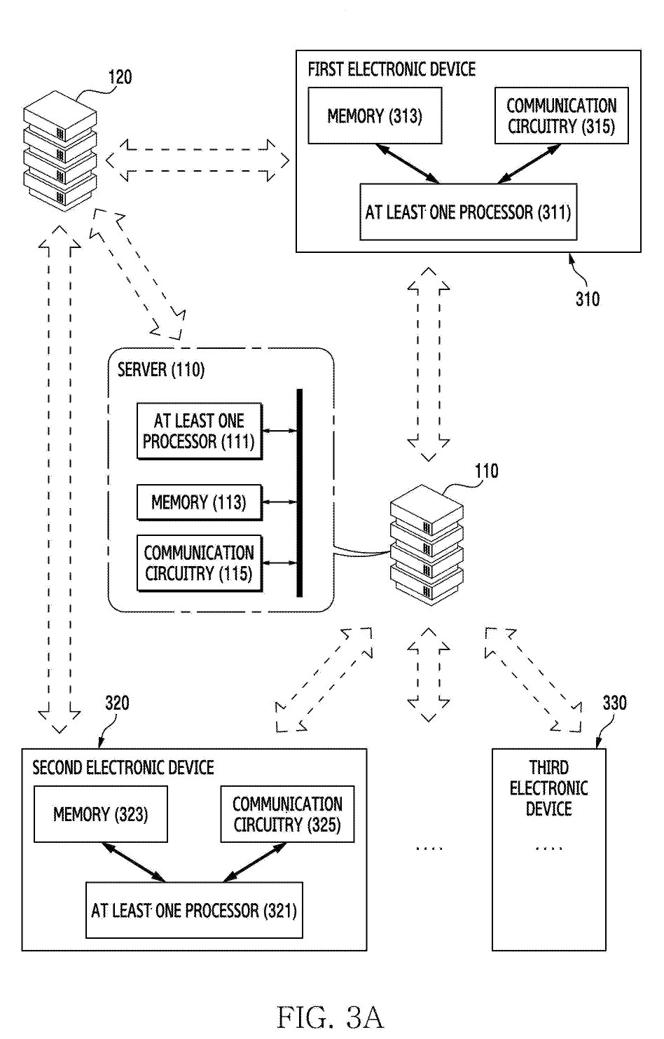

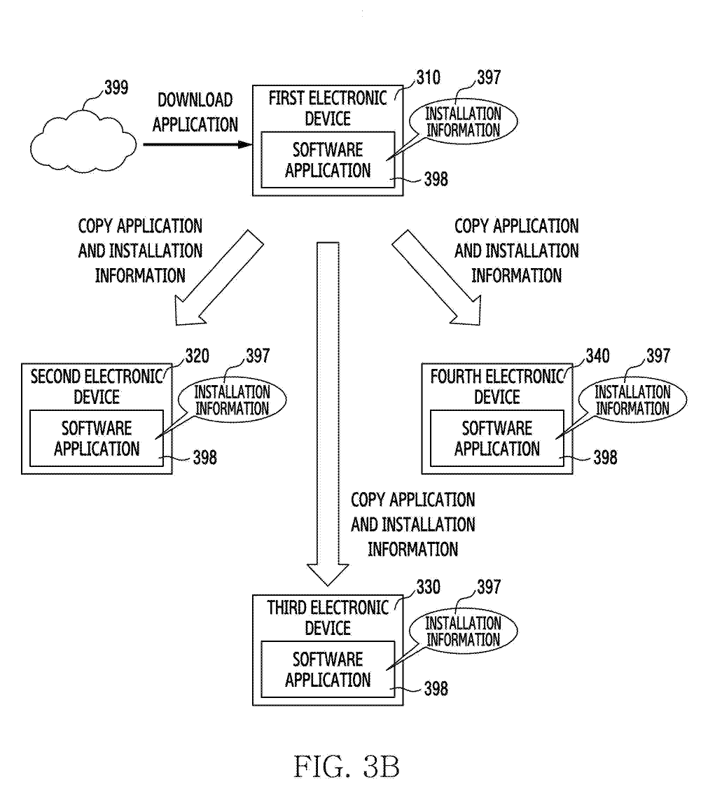

The server (e.g., the servers 110 and 120) may include a computer designed to provide a function of the server, such as a workstation. An embodiment is not limited thereto, and the server may include a personal computer configured to execute a software application (e.g., a software application 398 of FIG. 3B), and/or a combination of the personal computers. The server may include a group (or a cluster) of the exemplified workstations and/or personal computers.

In an embodiment, a service provider may provide or operate an automated service by using the server. The service may include a game service. The game service may be provided for network-based playing of games such as a role playing game (RPG), a massive multi-user online RPG (MMORPG), a first person shooter (FPS), and/or a puzzle. Through the game service, different users (e.g., users of the game service) may be connected to each other through a network, and may cooperate, or may compete. The server may support or execute functions (e.g., matching of users, provision of a virtual space 130 such as a battlefield, trading of virtual items such as a market, and/or chatting between users) related to the game service.

Referring to FIG. 1, the servers 110 and 120 included in the network for providing different services are illustrated. The server 110 may be configured to relay a connection between a user and various game services (e.g., a game service provided by the server 120) provided through the network. A service provided through the server 110 may be referred to as a game platform service, a game launching service, a game publishing service, and/or a game relaying service.

Referring to FIG. 1, the server 110 may cause the server 120 for providing a game service to provide the user of the game platform service with a user experience related to the game service. The server 110 may store, in a user database related to users of the game platform service, information indicating one or more game services to which the users have subscribed. The information may further include information (e.g., account information and/or authentication information for logging in to the game service) for accessing another server for a game service, such as the server 120.

Referring to FIG. 1, the server 110 may store information indicating at least one game service to which the users of the game platform service have subscribed in the user database. The user database may include a record having a user subscribed to the game platform service as a unit thereof. The record may include at least one game service to which a corresponding user has subscribed, and/or information for accessing (or logging in to) the at least one game service.

Referring to FIG. 1, users U1 and U2 of a game platform service provided by the server 110 are illustrated. Although the user U1 owning the user terminals 141, 142, and 143 and the user U2 owning the user terminals 151 and 152 are illustrated, the number of users of the server 110 and the number of user terminals owned by each of the users are not limited thereto. A user of the game platform service may be referred to as a user.

Referring to FIG. 1, various appearances of a user terminal (or user equipment) of a user are illustrated. The user terminal may include a smartphone (e.g., the user terminals 141 and 152), a smartpad, and/or a tablet PC. The user terminal may include a personal computer such as a desktop (e.g., the user terminals 142 and 151) and a laptop. The user terminal may include a portable gaming device (e.g., the user terminal 143) dedicated to the game service, and/or a gaming console. The user terminal may include a smart accessory such as a smartwatch, and/or a head-mounted device (HMD) such as a smartwatch. An embodiment of the user terminal is not limited thereto.

Referring to FIG. 1, the user U1 may access the game platform service provided by the server 110 by using at least one of the user terminals 141, 142, and 143. Similarly, the user U2 may access the game platform service by using at least one of the user terminals 151 and 152. A software application for communicating with the server 110 may be installed in at least one of the user terminals 141, 142, 143, 151, and 152. The software application (e.g., the software application 398 of FIG. 3B) may be referred to as a game platform application, a game platform program, a game launcher, and/or a client application.

Hereinafter, the user terminal 141, which is one of the user terminals 141, 142, 143, 151, and 152, is taken as an example to describe a connection relationship between the user terminal 141 and the server 110 and between the user terminal 141 and the server 120.

For example, by using the user terminal 141 executing the game launcher, the user U1 may access the game platform service provided by the server 110. The user terminal 141 executing the game launcher may establish a communication link L1 between the user terminal 141 and the server 110. The communication link L1 may include a logical connection (e.g., a logical connection distinguished by a session) established for data communication between the user terminal 141 and the server 110 in the network. Similarly, in response to an input of the user U2 for executing the game launcher of the user terminal 151, the user terminal 151 may establish a communication link L2 between the server 110 and the user terminal 151.

The server 110 that has detected the user terminal 141 executing the game launcher by using the communication link L1, may identify a user account logged in to the user terminal 141. By comparing the user database stored in the server 110 and authentication information (e.g., an ID, a password, a personal identification number (PIN), and/or an one-time password (OTP)) transmitted from the user terminal 141, the server 110 may authenticate the user U1 who has executed the game launcher in the user terminal 141. Based on the authentication, the user terminal 141 may display a screen provided by the game launcher. For example, a state of the user terminal 141 executing the game launcher may include a state (e.g., a locked state, and/or a state before login) before authenticating the user U1 and a state after authenticating the user U1.

Referring to FIG. 1, in a state in which the users U1 and U2 of the user terminals 141 and 151 connected to the server 110 through the communication links L1 and L2 are authenticated, the server 110 may support interaction between the users U1 and U2. For example, the server 110 may support transmission (e.g., streaming) and/or reception of a message (e.g., a text message), an image, a video, a sound (e.g., voice chatting), and/or a post between the users U1 and U2. The server 110 configured to provide the game platform service may execute or support functions related to online activities of the users U1 and U2 related to a game.

In a state of having accessed the game platform service by using the user terminal 141, the user U1 may access a game service connected to the game platform service. For example, the user terminal 141 executing the game launcher may receive an input for accessing the game service. In response to the input for accessing the game service, detected by using the game launcher, the user terminal 141 may transmit, to the server 110 through the communication link L1, a signal related to the input. The server 110 that has received the signal may communicate with the server 120 providing the game service indicated by the signal. For example, by using a communication link L3 established between the servers 110 and 120, the server 110 may transmit information (e.g., authentication information required for the server 120 providing the game service to authenticate the user U1) related to the user U1 logged in to the game platform service. Based on the authentication of the user U1 using the information, a communication link L4 between the user terminal 141 of the user U1 and the server 120 may be established.

Similarly, from the user terminal 151 in which the user U2 is logged in, the server 110 may receive a signal notifying reception of the input for accessing the game service. The server 110 that has received the signal may transmit, to the server 120, a signal causing establishment of a communication link L5 between the user terminal 151 and the server 120 by using the communication link L2. Through the communication link L5 established by the signal, direct communication between the user terminal 151 and the server 120 may be performed. The embodiment is not limited thereto, and by using the communication links L2 and L3, indirect communication between the server 120 providing the game service and the user terminal 151 may be performed.

As described above, in a state in which the communication links L4 and L5 between user terminals (e.g., the user terminals 141 and 151) and the server 120 are established so that the game service is provided to the user terminals of each of the users U1 and U2, the server 120 for providing the game service may transmit, to each of the user terminals, information on at least a portion of the virtual space 130. For example, the server 120 may transmit, to the user terminal 141 of the user U1, information related to a portion of the virtual space 130 (e.g., information for rendering the portion of the virtual space 130) including a position A related to the user U1. For example, the server 120 may transmit, to the user terminal 151 of the user U2, information related to another portion of the virtual space 130 including a position B related to the user U2.

Although an exemplary operation in which a user (e.g., the users U1 and U2) accesses the game service by using the server 110 providing the game platform service has been described, the embodiment is not limited thereto. For example, the user may directly access the server 120 for the game service without the server 110 by using a game application installed in a user terminal.

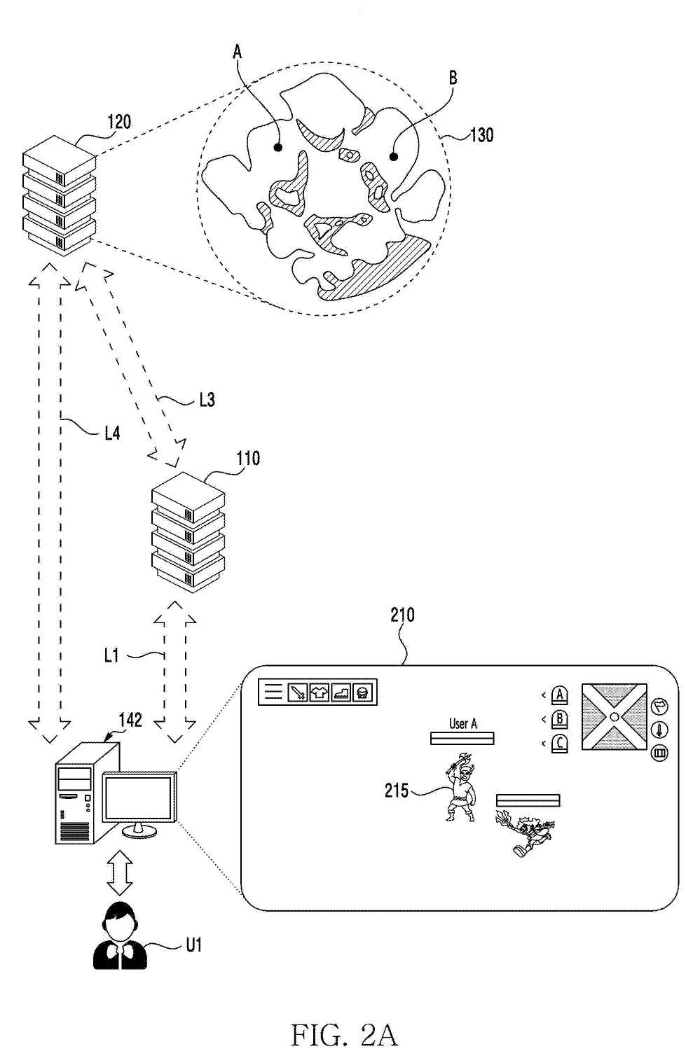

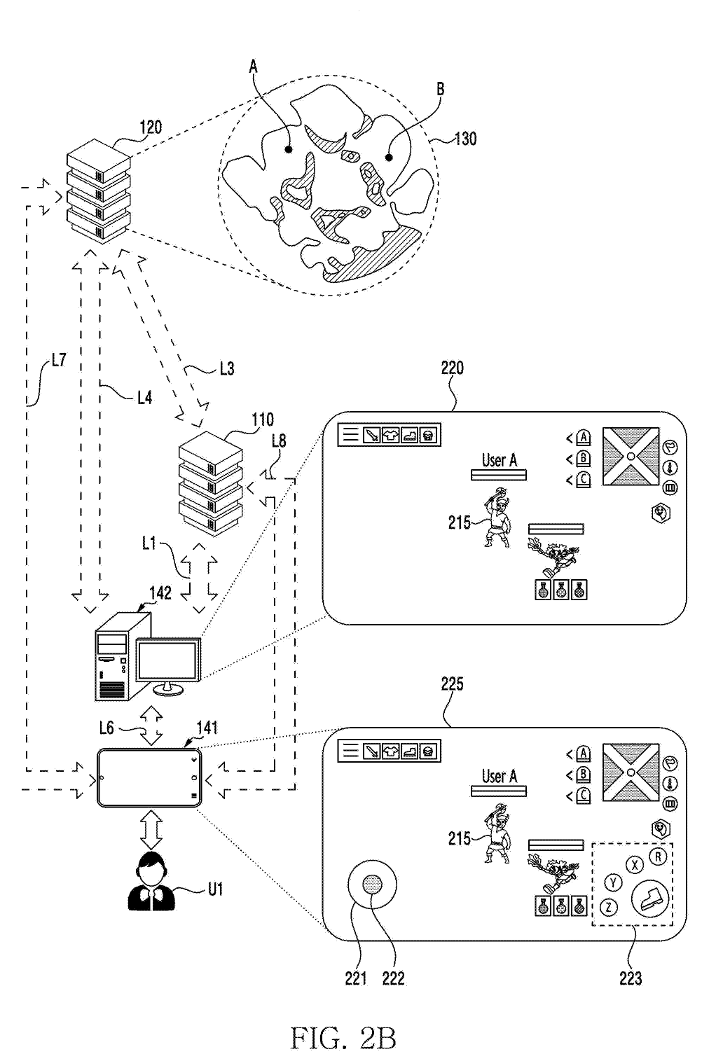

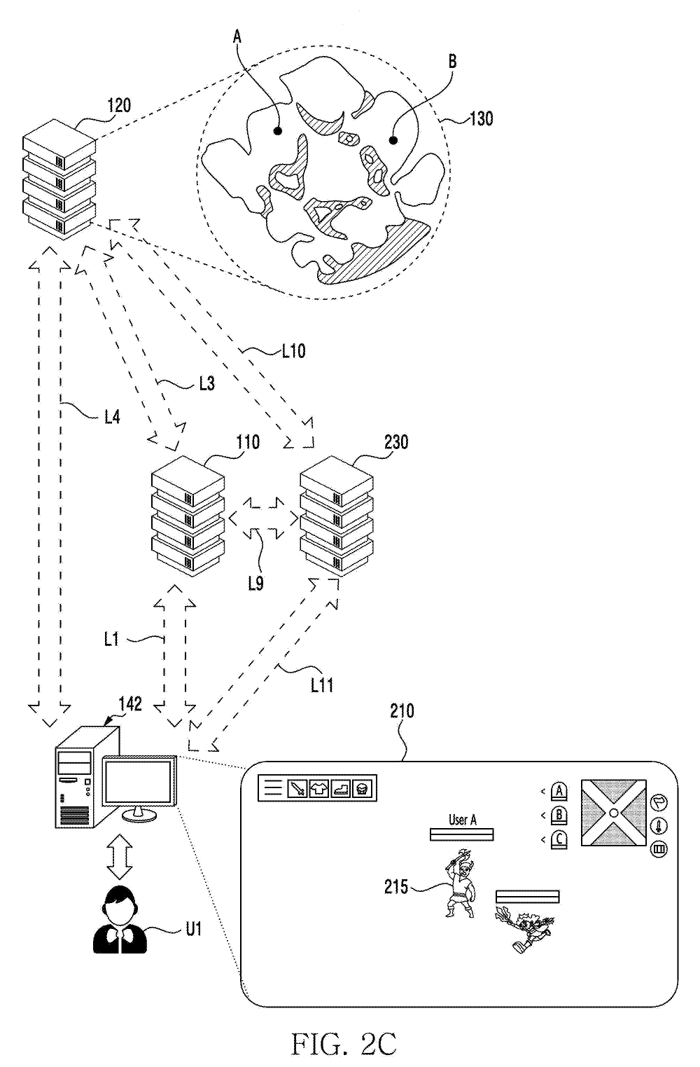

Hereinafter, with reference to FIGS. 2A to 2B, an exemplary operation of a user terminal and/or a server related to a communication link connected for a game service and/or a game platform service will be described. For example, an exemplary operation of the server 110 based on the user U1 and the user terminal 142 is described, but the embodiment is not limited thereto.

FIGS. 2A, 2B, and 2C illustrate an exemplary case of providing a user experience related to a game by using a plurality of user terminals (e.g., the user terminals 141 and 142). Referring to FIGS. 2A to 2C, an exemplary state in which communication links L1, L3, and L4 among a server 110 for a game platform service, a server 120 for a game service, and a user terminal 142 are established is illustrated. The server 110 may establish the communication link L4 between the server 120 and the user terminal 142 by communicating with the server 120 according to the operation described with reference to FIG. 1. For the communication between the server 110 and the user terminal 142, in the user terminal 142, a game launcher related to the game platform service may be executed.

Referring to FIGS. 2A to 2C, the user terminal 142 that has executed the game launcher may execute a game application in response to an input for executing the game application. The user terminal 142 that has executed the game application may display a screen 210 provided from the game application. The exemplary screen 210 including a player character (PC) 215 controllable by an input received through the user terminal 142 is illustrated, but an embodiment is not limited thereto. By using a signal received from the server 120 through the communication link L4, the user terminal 142 may display the screen 210 including the PC 215 included in a virtual space 130.

Referring to FIG. 2A, the user terminal 142 executing the game application may output the screen 210 to a user U1 and may receive, from the user U1, an input (e.g., an input for controlling the PC 215) related to the game. The user terminal 142 that has received the input may transmit, to the server 120 through the communication link L4, a first signal indicating the input. The user terminal 142 may further receive, from the server 120 through the communication link L4, a second signal indicating the virtual space 130 and/or a state of the PC 215 changed by the input. The user terminal 142 that has received the second signal may at least partially change the screen 210. For example, the user terminal 142 may play an animation related to the PC 215 within the screen 210.

In a case that an input for executing the game application is received through the game launcher, the user terminal 142 may execute the game application in association with the game launcher. By using the association, the user terminal 142 may execute a function of the game launcher based on a state of the game application. The function may include transmitting, to the server 110, a signal notifying the state (e.g., streaming of the screen 210 for live broadcasting). The function may include a remote play function of the game application executed in the user terminal 142 by using another user terminal different from the user terminal 142.

Referring to FIG. 2B, the user terminals 141 and 142 connected to each other for the remote play function are illustrated. The user terminals 141 and 142 may be connected through a short-range wireless communication protocol such as Wi-Fi Direct and/or Bluetooth. The embodiment is not limited thereto, and the user terminals 141 and 142 may be connected to each other through a cellular protocol such as long-term evolution (LTE), 5G new radio (NR), 6G, and/or above-6G. It is assumed that the game launcher is installed in all of the user terminals 141 and 142, and that authentication of the user U1 in each of the user terminals 141 and 142 based on the game launcher is completed.

In a case of executing the game application in the user terminal 141 having relatively limited resources such as a smartphone, a quality of a user experience related to the game may be reduced. The quality may be evaluated by indicators such as frames-per-second (fps), response delay, and/or resolution. A quality of a user experience in a case of executing the game application in the user terminal 142 that is a desktop may be better than the quality of the user experience in a case of executing the game application in the user terminal 141. Referring to FIG. 2B, the user terminal 142 may transmit, to the user terminal 141, a screen 220 generated (or rendered) by processing circuitry (e.g., a graphic processing unit (GPU)) of the user terminal 142. The transmitting of the screen 220 may include transmitting a bitstream representing the screen 220 (e.g., streaming) through a communication link L6.

In an exemplary state of FIG. 2B in which the user terminal 142 displays the screen 220 to the user terminal 141, the user terminal 141 may display the screen 220 on a display based on execution of the game launcher. For example, without installation and/or execution of the game application for communicating with the server 120, the user terminal 141 may display, on the display, the screen 220 related to the game service provided by the server 120. The user terminal 141 may display the screen 220 provided by the user terminal 142 based on the execution of the game launcher.

Referring to FIG. 2B, in an embodiment in which the user terminal 142 generates the screen 220 to be displayed by the user terminal 141, the user terminal 142 may display the screen 220 including a UI related to the user terminal 141 that is the smartphone. The UI may include a virtual joystick including a visual object 222 having a circular shape that is draggable (or movable) by a touch input on an area 221 having a circular shape. The UI may include a group 223 of touchable visual objects capable of adjusting the state of the PC 215. Comparing FIGS. 2A and 2B, the screen 210 of FIG. 2A, which is displayed through a display of the user terminal 142 that is the desktop, may not include the visual object 222 and/or the group 223. In a state in which the screen 220 is transmitted to the user terminal 141 that is the smartphone, the user terminal 141 that has received the screen 220 may overlay, on the screen 220, the area 221 including the visual object 222 and the group 223. For example, a screen 225 displayed on a display of the user terminal 141 may further include the visual object 222, the area 221, and the group 223 for guiding a touch input.

Referring to FIG. 2B, while displaying the screen 225 based on the screen 220 provided by the user terminal 142, the user terminal 141 may receive an input of the user U1 related to the screen 225. In response to the input, the user terminal 141 may transmit, to the user terminal 142, a signal indicating the input. The user terminal 142 that has received the signal may at least partially change the virtual space 130 and/or the state of the PC 215 using the input corresponding to the signal, by communicating with the server 120. The user U1 may view, through the user terminal 141, the screen 220 representing the virtual space 130 and/or the state of the PC 215 that is at least partially changed.

As described above, an embodiment in which the server 120 for providing the game service of FIG. 2B and the user terminal 142 directly communicate with each other and the user terminal 141 indirectly communicates with the server 120 by using the user terminal 142 has been described, but the embodiment is not limited thereto. For example, the user terminal 141 that has received the input of the user U1 related to the screen 225 may transmit, to the server 120 through a communication link L7, a signal including information related to the input. The signal may be directly transmitted to the server 120 independently of the communication links L4 and L6 established by the user terminal 142. For example, in order to reduce a delay for the input of the user U1 or to improve responsiveness of the game service provided by the server 120, the user terminal 141 may transmit the signal through the communication link L7. The server 120 that has received the signal may transmit, to the user terminal 142 through the communication link L4, a signal (or information) indicating a state of the virtual space 130 changed based on the signal. The user terminal 142 that has received the signal may perform rendering for the screen 220 to be provided to the user terminal 141 through the communication link L6. After a signal related to the rendered screen 220 is transmitted to the user terminal 141 through the communication link L6, the user terminal 141 may display the screen 225 (e.g., a screen in which the visual object 222, the area 221, and the group 223 are overlaid on the screen 220) based on the signal.

For example, in a case that the communication link L6 between the user terminals 141 and 142 is blocked, the user terminal 141 may establish at least one of the direct communication link L7 between the server 120 for providing the game service and the user terminal 141, and/or a direct communication link L8 between the server 110 for providing the game platform service and the user terminal 141.

Although an operation in which a signal representing the screen 220 is transmitted between the user terminals 141 and 142 commonly logged in by the user U1 has been described, the embodiment is not limited thereto. For example, the user terminal 142 may transmit, through the server 110, the signal representing the screen 220 to user terminals of other users logged in to the server 110. A function in which the user terminal 142 transmits the signal to the user terminals of the other users logged in to the server 110 may be referred to as a broadcasting function.

Referring to FIG. 2C, a server 230 for a cloud gaming may be connected to the user terminal 142. For example, in a case that a request for providing the game service based on a cloud is identified in the user terminal 142, the server 110 may request, to the server 230, provision of a cloud service based on the server 230. The request may be transmitted to the server 230 through a communication link L9 between the server 110 and the server 230. In response to the request, the server 230 may establish a communication link L10 between the server 120 for the game service and the server 230 and a communication link L11 between the server 120 and the user terminal 142. The request transmitted through the communication link L9 may include information related to the user terminal 142 that has transmitted the request and/or the game service.

In an embodiment, the server 230 may perform rendering of the screen 210 to be displayed on the user terminal 142. The server 230 may transmit, to the user terminal 142 through the communication link L11 between the user terminal 142 and the server 230, a signal (or a bitstream) related to the screen 210 rendered by the server 230. The user terminal 142 that has received the signal may display, on the display, the screen 210 indicated by the signal.

In an exemplary state of FIG. 2C, the user terminal 142 displaying the screen 210 may receive a user input related to the screen 210. In response to a user input received from the user U1, the user terminal 142 may transmit, to the server 230 through the communication link L11, a signal indicating the user input. The server 230 that has received the signal may execute a function related to the user input. The server 230 that has executed the function may include, for example, at least partially changing a state of the virtual space 130 provided by the server 110 by communicating with the server 110 through the communication link L10. For example, the server 230 that has executed the function may include re-rendering the screen 210 to be transmitted to the user terminal 142 based on the state of the partially changed virtual space 130. For example, the server 230 that has executed the function may further transmit, through the communication link L11, a signal related to the re-rendered screen 210.

As described above, by using the game launcher, the user terminal 141 may display the screen 220 of the game application executed in another user terminal (in an embodiment of FIG. 2B, the user terminal 142) and may respond to interaction of the user U1 related to the screen 220. The user terminal 141 may indirectly perform graphic rendering (e.g., visualization of a three-dimensional graphic object) by using resources of the user terminal 142. Even though the user terminal 141 does not have capacity (e.g., available capacity of a flash storage) required to install the game application or does not have resources (e.g., specifications of a GPU and/or a CPU) required to execute the game application, the user terminal 141 that has executed the game launcher may provide a user experience related to the game application.

FIG. 3A illustrates an exemplary block diagram of a server and an electronic device in a network environment.

Referring to FIG. 3A, an environment illustrated in FIG. 3A may include the server 110 of FIG. 1 and a plurality of electronic devices 310, 320, and 330. The plurality of electronic devices 310, 320, and 330 may be connected to the server 110 based on a wired network and/or a wireless network by using each of communication circuitry 315 and 325. For example, the wired network may include a network such as the Internet, a local area network (LAN), a wide area network (WAN), Ethernet, or a combination thereof. The wireless network may include a network such as long term evolution (LTE), 5G new radio (NR), wireless fidelity (Wi-Fi), Zigbee, near field communication (NFC), Bluetooth, Bluetooth low-energy (BLE), and/or a combination thereof. For example, the first electronic device 310 and the second electronic device 320 may be indirectly connected to the server 110 through one or more routers and/or one or more access points (APs). For each of the plurality of electronic devices 310, 320, and 330 connected to the server 110, a network address of a network used for access to a service may be assigned. For example, the first electronic device 310 may access the service by using a network address assigned to the first electronic device 310. For example, the second electronic device 320 may access the service by using a network address assigned to the second electronic device 320. For example, the third electronic device 330 may access the service by using a network address assigned to the third electronic device 330. For example, the network address assigned to each of the plurality of electronic devices 310, 320, and 330 may include an internet protocol (IP) defined by four groups.

The service may be provided by the server 110 and/or a server 120 for providing the service. For example, in a case that a game application is executed in each of the plurality of electronic devices 310, 320, and 330, each of the plurality of electronic devices 310, 320, and 330 may access the service by being connected to the server 120 for providing the service. For example, the service may include a game platform service provided to users that has subscribed to the service. The service may be an example of the game service of FIGS. 1-2C. For example, the game platform service may include a program, a game application, and/or a library for providing the game platform service. For example, the server 110 may provide, to the plurality of electronic devices 310, 320, and 330, information on a virtual space associated with the game service. The virtual space may indicate a virtual environment (or a game environment) implemented in the game service. Each of the plurality of electronic devices 310, 320, and 330 may be connected to the server 120 by executing the game application by using a software application (e.g., a game launcher) for the execution of the game application. In a case that each of the plurality of electronic devices 310, 320, and 330 is connected to the server 110 and/or the server 120 based on the game application executed through the software application, each of the plurality of electronic devices 310, 320, and 330 may access the service.

The plurality of electronic devices 310, 320, and 330 may process an operation request related to the game application received to the plurality of electronic devices 310, 320, and 330 that are client devices based on linkage with a database (e.g., memory 113 of the server 110) storing data for the execution of the game application related to the service, and may transmit information on a result of the processing to the server 110. For example, the operation request related to the game application received from the plurality of electronic devices 310, 320, and 330 to the server may include an operation request related to execution of the game by using the game application.

Referring to FIG. 3A, the server 110 may include at least one of at least one processor 111, the memory 113, and communication circuitry 115. The at least one processor 111, the memory 113, or the communication circuitry 115 may be electrically and/or operably coupled with each other by an electronic component such as a communication bus. A type and/or the number of hardware components included in the server 110 is not limited as illustrated in FIG. 3A. For example, the server 110 may include only a portion of hardware components illustrated in FIG. 3A.

The at least one processor 111 of the server 110 may include a hardware component for processing data based on one or more instructions. The hardware component for processing data may include, for example, an arithmetic and logic unit (ALU), a field programmable gate array (FPGA), and/or a central processing unit (CPU). For example, the at least one processor 111 of the server 110 may include one or more structures. For example, the at least one processor 111 may have a structure of a multi-core processor such as a dual core, a quad core, or a hexa core.

The server 110 may identify account information of users subscribed to a service (e.g., the game platform service) based on the server 110 and/or the server 120 and/or may store the account information in the memory 113 in the server. For example, the account information of the users may include player character (PC) information corresponding to the account information in a game service connected to the game platform service. In addition, for example, the account information of the users may include information on electronic devices owned by the users. For example, the PC information may include a name of the character generated in the game service, information on the character, and/or an item possessed by the character.

The server 110 may identify the account information of the users stored in a database in the server 110 based on authentication information received from each of the plurality of electronic devices 310, 320, and 330 for access from the plurality of electronic devices 310, 320, and 330 to the service. For example, the authentication information may include a user identitfier and a password for authentication (or login) performed in a software application used for game execution and/or in a homepage used for game execution.

The account information may be linked with the authentication information. As a non-limiting example, first account information included in the account information may be linked with first authentication information included in the authentication information. For example, the first account information may be used for access to the service executed through the software application. For example, by inputting the first authentication information in the first electronic device 310, a user may access the software application installed in the first electronic device 310. In a case that the game application is executed through the software application installed in the first electronic device 310, the server 110 and/or the server 120 for providing the service may provide the service to the first electronic device 310. At least one processor 311 of the first electronic device 310 may transmit the first authentication information to the server 110 through the communication circuitry 315. The server 110 may identify the first account information from the first authentication information received through the communication circuitry 115 and may provide the identified first account information to the first electronic device 310. By executing the game application in the first electronic device 310, the first electronic device 310 may access the service by using the first account information.

As a non-limiting example, second account information included in the account information may be linked with second authentication information included in the authentication information. For example, the second account information may be used for access to the service executed through the software application. For example, by inputting the second authentication information in the second electronic device 320, the user may access the application installed in the second electronic device 320. In a case that the game application is executed through the application installed in the second electronic device 320, a server for providing the service may provide the service to the second electronic device 320. At least one processor 321 of the second electronic device 320 may transmit the second authentication information to the server 110 through the communication circuitry 325. The server 110 may identify the second account information from the second authentication information received through the communication circuitry 115 and may provide the identified second account information to the second electronic device 320. By executing the game application in the second electronic device 320, the second electronic device 320 may access the service by using the second account information.

The communication circuitry 115 of the server 110 may include a hardware component for supporting transmission and/or reception of a signal between the server 110 and the plurality of electronic devices 310, 320, and 330. For example, the communication circuitry 115 may include at least one of a MODEM, an antenna, and an optic/electronic (O/E) converter. For example, the communication circuitry 115 may support transmission and/or reception of a signal based on various types of protocols such as Ethernet, a local area network (LAN), a wide area network (WAN), wireless fidelity (Wi-Fi), Bluetooth, Bluetooth low energy (BLE), ZigBee, long term evolution (LTE), and/or 5G new radio (NR).

Based on receiving at least one signal from at least one electronic device owned by a user of the plurality of electronic devices 310, 320, and 330, the server 110 may identify an input of the user. The server 110 and/or the plurality of electronic devices 310, 320, and 330 may control a PC based on identifying the input of the user.

Referring to FIG. 3A, the plurality of electronic devices 310, 320, and 330 may include a personal computer such as a laptop and a desktop, a smartphone, a smart pad, and a tablet personal computer (PC). For example, the first electronic device 310 may include the at least one processor 311, memory 313, and the communication circuitry 315. The at least one processor 311, the memory 313, and/or the communication circuitry 315 may be electrically and/or operably coupled with each other by an electronic component such as a communication bus. A type and/or the number of hardware components included in the plurality of electronic devices 310, 320, and 330 is not limited as illustrated in FIG. 3A. For example, the first electronic device 310 may include only a portion of hardware components illustrated in FIG. 3B.

At least one processor (e.g., the at least one processor 311 of the first electronic device 310 and the at least one processor 321 of the second electronic device 320) of each of the plurality of electronic devices 310, 320, and 330 may include a hardware component for processing data based on one or more instructions. The hardware component for processing data may include, for example, an arithmetic and logic unit (ALU), a field programmable gate array (FPGA), and/or a central processing unit (CPU). For example, the at least one processor 311 of the first electronic device 310 and/or the at least one processor 321 of the second electronic device 320 may include one or more structures. For example, the at least one processor 311 of the first electronic device 310 may have a structure of a multi-core processor such as a dual core, a quad core, or a hexa core.

Memory (e.g., the memory 313 of the first electronic device 310 and memory 323 of the second electronic device 320) of each of the plurality of electronic devices 310, 320, and 330 may include a hardware component for storing data and/or instructions inputted to and/or outputted from each of the at least one processors 311 and 321. For example, the memory 313 of the first electronic device 310 may include a volatile memory such as a random-access memory (RAM) and/or a non-volatile memory such as a read-only memory (ROM). The volatile memory may include, for example, at least one of a dynamic RAM (DRAM), a static RAM (SRAM), a Cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multi media card (eMMC). The hardware component and a configuration of the memory 323 of the second electronic device 320 may be substantially identical to the hardware component and a configuration of the memory 313 of the first electronic device 310.

A set of the one or more instructions may be referred to as firmware, an operating system, a process, a routine, a sub-routine, and/or an application. Hereinafter, a game application being installed in the plurality of electronic devices 310, 320, and 330 may mean that one or more instructions provided in a form of the game application are stored in memory (e.g., the memory 313 or the memory 323) and that one or more applications are stored in an executable format (e.g., a file having an extension designated by an operating system of the first electronic device 310) that is executable by at least one processor (e.g., the at least one processor 311). For example, the game application may include a program and/or a library related to the game service provided to the user.

Communication circuitry (e.g., the communication circuitry 315 of the first electronic device 310 and the communication circuitry 325 of the second electronic device 320) of each of the plurality of electronic devices 310, 320, and 330 may include a hardware component for supporting transmission and/or reception of a signal between the plurality of electronic devices 310, 320, and 330 and the server 110. For example, the communication circuitry 315 of the first electronic device 310 may be used for transmission and/or reception of a signal between the first electronic device 310 and the server 110. As a non-limiting example, the communication circuitry 325 of the second electronic device 320 may be used for transmission and/or reception of a signal between the second electronic device 320 and the server 110. The communication circuitry (e.g., the communication circuitry 315 and the communication circuitry 325) of each of the plurality of electronic devices 310, 320, and 330 may include at least one of a MODEM, an antenna, and an optic/electronic (O/E) converter. For example, the communication circuitry 315 of the first electronic device 310 may support transmission and/or reception of a signal based on various types of protocols such as Ethernet, a local area network (LAN), a wide area network (WAN), wireless fidelity (Wi-Fi), Bluetooth, Bluetooth low energy (BLE), ZigBee, long term evolution (LTE), and 5G new radio (NR). As a non-limiting example, the communication circuitry 325 of the second electronic device 320 may support transmission and/or reception of a signal based on various types of protocols such as Ethernet, a local area network (LAN), a wide area network (WAN), wireless fidelity (Wi-Fi), Bluetooth, Bluetooth low energy (BLE), ZigBee, long term evolution (LTE), and 5G new radio (NR).

FIG. 3B illustrates a situation in which a software application installed in an electronic device and installation information related to the software application are copied to a plurality of electronic devices.

For example, the first electronic device 310 may install (or download), from a platform 399 providing a software application 398, the software application for executing a game application. For example, the software application may be referred to as a game platform application, a game platform program, a game launcher, and/or a client application. The software application 398 installed in the first electronic device 310 may include installation information 397 related to the software application 398. For example, the installation information 397 may be granted to the first electronic device 310 when the software application 398 is installed in the first electronic device 310. For example, the installation information 397 may include information for identifying the first electronic device 310 using the first account information accessed to the service by the server 110. As a non-limiting example, the information for identifying the first electronic device 310 related to the first account information may include a universally unique identifier (UUID) generated or granted as the software application 398 is installed in the first electronic device 310. For example, as the game application is executed by using the software application 398 in the first electronic device 310, the first electronic device 310 may be connected to the service by using the first account information. The server 110 may receive the installation information 397 from the first electronic device 310 connected to the service by using the first account information. The server 110 may identify the first electronic device 310 by using the received installation information 397. In a case that the game application is executed in the first electronic device 310, the server 110 may obtain, together with the installation information 397, a network address assigned to the first electronic device 310 (or a network address related to the first account information).

The software application 398 installed in the first electronic device 310 may be copied to the second electronic device 320, the third electronic device 330, and the fourth electronic device 340. As a non-limiting example, the software application 398 installed in the first electronic device 310 may be stored in the memory 313 of the first electronic device 310. The software application 398 installed in the first electronic device 310 may be copied to the second electronic device 320 to the fourth electronic device 340 by copying data of the memory 313 of the first electronic device 310. For example, copying of the data may include copying all data stored in a hard disk of the first electronic device 310. As a non-limiting example, the software application 398 installed in the first electronic device 310 may be copied to the second electronic device 320 to the fourth electronic device 340 as a file in which the software application 398 installed in the first electronic device 310 is stored is copied. The software application 398 copied to the second electronic device 320 to the fourth electronic device 340 may be stored (or installed) in memory of each of the second electronic device to the fourth electronic device 340.

In a case that the software application 398 is copied from the first electronic device 310 to the second electronic device 320 to the fourth electronic device 340, the installation information 397 included in the software application 398 may also be copied together. The installation information 397 copied to the second electronic device 320 to the fourth electronic device 340 may be stored (or installed) in the memory of each of the second electronic device 320 to the fourth electronic device 340. For example, in a case that the software application 398 is copied from the first electronic device 310 to the second electronic device 320 to the fourth electronic device 340, the universally unique identifier generated as the software application 398 is installed in the first electronic device 310 may also be copied together. As the installation information 397 is copied, the universally unique identifier of the first electronic device 310 to the fourth electronic device 340 may all be identical.

The first electronic device 310 to the fourth electronic device 340 in which the software application 398 having the installation information 397 is stored may access the service by using different account information. For example, the first electronic device 310 may access the service by using the first account information. For example, the second electronic device 320 may access the service by using the second account information. For example, the third electronic device 330 may access the service by using third account information. For example, the fourth electronic device 340 may access the service by using fourth account information.

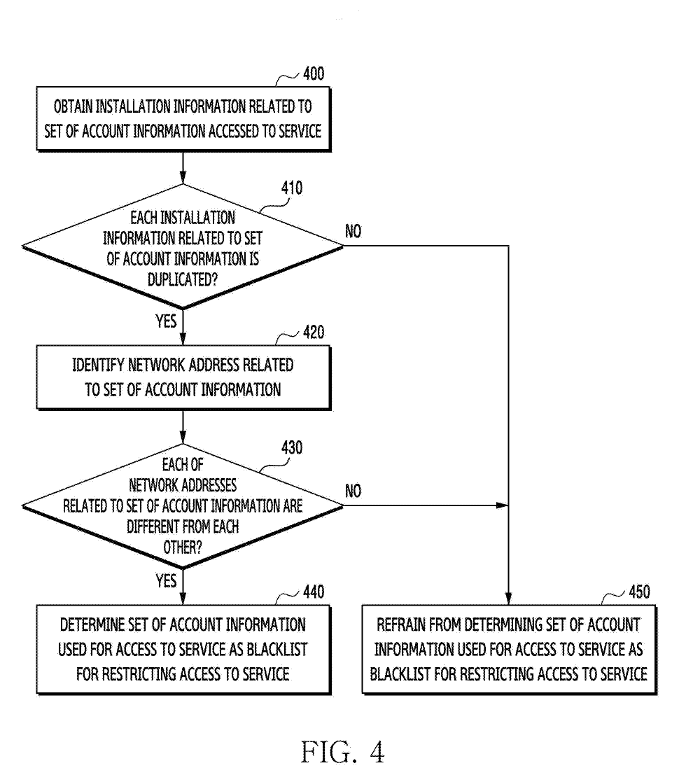

As described above in FIG. 3B, in a case that the software application 398 is copied, different electronic devices may include the identical installation information 397. The present disclosure provides that, in a case that a plurality of electronic devices (e.g., the first electronic device 310, the second electronic device 320, the third electronic device 330, and the fourth electronic device 340) in which the identical installation information 397 accessed to the service is stored satisfy a defined condition, the server 110 may determine account information used for access from each of the plurality of electronic devices to the service as a blacklist. A specific content regarding the defined condition will be described below with reference to FIG. 4.

FIG. 4 is a flowchart illustrating an operation of a server determining account information as a blacklist based on installation information and a network address related to the account information.

At least a portion of the method of FIG. 4 may be performed by the server 110 of FIG. 3A. For example, at least a portion of the method may be controlled by at least one processor 111 of the server 110. In the following embodiment, each operation may be sequentially performed, but is not necessarily performed sequentially. For example, an order of each operation may be changed, and at least two operations may be performed in parallel.

In operation 400, the at least one processor 111 may obtain installation information related to a set of account information accessed to a service. The service may be substantially identical to the service of FIG. 3A. The set of account information may include first account information used by a first electronic device 310 among a plurality of electronic devices (e.g., the first electronic device 310 and a second electronic device 320) to access the service and second account information used by the second electronic device 320 to access the service.

The at least one processor 111 may obtain installation information (e.g., installation information 397) of each of the plurality of electronic devices using the set of account information connected to the service. For example, each of the plurality of electronic devices may use a software application (e.g., a software application 398) installed (or stored) in each of the plurality of electronic devices for access to the service. For example, each of the plurality of electronic devices may execute a game application (e.g., the game application of FIG. 3A) through the software application installed in each of the plurality of electronic devices. The at least one processor 111 may obtain installation information included in the software application installed in each of the plurality of electronic devices.

For example, the at least one processor 111 may obtain, from each of the plurality of electronic devices by using communication circuitry 115, each installation information included in the software application installed in each of the plurality of electronic devices at a defined time.

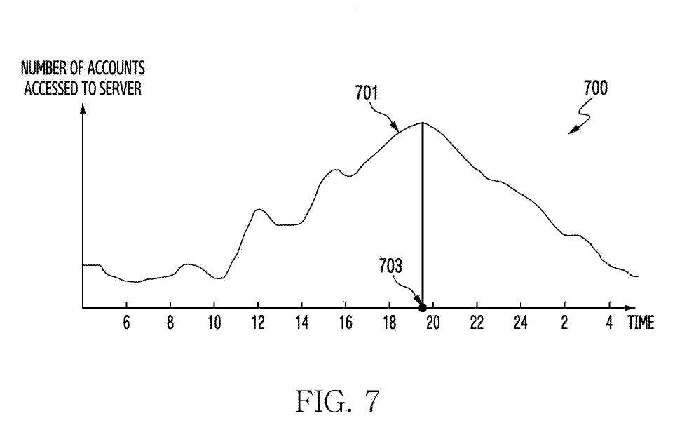

For example, the defined time may include a time at which the number of accounts accessed to the service among a designated time is maximum. As a non-limiting example, the designated time may include 24 hours (or, one day). For example, the at least one processor 111 may identify the number of accounts used by the plurality of electronic devices accessed to the service to access the service. The defined time may include a time at which the number of the plurality of electronic devices accessed to the service by using the accounts is maximum. A specific content regarding the defined time and the designated time will be described with reference to FIG. 7.

In operation 410, the at least one processor 111 may identify whether each installation information related to the set of account information is duplicated. For example, the at least one processor 111 may identify whether the installation information of the software application installed in each of the plurality of electronic devices accessed to the service by using the set of account information is duplicated. For example, the at least one processor 111 may identify whether installation information of the software application stored in the first electronic device 310 accessed to the service by using the first account information and installation information of the software application stored in the second electronic device 320 accessed to the service by using the second account information are duplicated.

For example, the at least one processor 111 may identify, by using (or, based on) the installation information obtained from the first electronic device 310, at least one electronic device that has transmitted installation information identical to the installation information obtained from the first electronic device 310. As a non-limiting example, in a case that the at least one processor 111 obtains identical installation information from the first electronic device 310 and the second electronic device 320 by using the communication circuitry 115, the at least one processor 111 may identify, based on the installation information obtained from the first electronic device 310, the second electronic device 320 that has transmitted the installation information identical to the installation information of the first electronic device 310.

In the operation 410, in a case that the at least one processor 111 identifies that each installation information related to the set of account information is duplicated, operation 420 may be performed. In contrast, in the operation 410, in a case that the at least one processor 111 identifies that each installation information related to the set of account information is not duplicated, operation 450 may be performed.

In the operation 420, the at least one processor 111 may identify a network address related to the set of account information. For example, the at least one processor 111 may obtain the network address related to the set of account information accessed to the service at the defined time. For example, the at least one processor 111 may identify, from the obtained network address, network addresses assigned to each of the plurality of electronic devices using account information within the set of account information. For example, the at least one processor 111 may identify a first network address related to the first account information within the set of account information. For example, the at least one processor 111 may identify a network address assigned to the first electronic device 310 accessed to the service by using the first account information. For example, the at least one processor 111 may identify a second network address related to the second account information within the set of account information. For example, the at least one processor 111 may identify a network address assigned to the second electronic device 320 accessed to the service by using the second account information.

For example, the at least one processor 111 may identify, from the network address obtained at the defined time, the first network address assigned to the first electronic device 310. As a non-limiting example, the at least one processor 111 may identify, from the network address obtained at the defined time, the second network address assigned to the second electronic device 320. As a non-limiting example, each of the first network address assigned to the first electronic device 310 and the second network address assigned to the second electronic device 320 may include an internet protocol (IP) address defined by four groups. For example, each of the four groups may have a designated range. As a non-limiting example, the designated range of each of the four groups of Internet Protocol version 4 (IPv4) may indicate a range of 0 or more and 255 or less. As a non-limiting example, the first network address assigned to the first electronic device 310 may be indicated as 115.21.138.174. As a non-limiting example, the second network address assigned to the second electronic device 320 may be indicated as 118.36.68.208.

In operation 430, the at least one processor 111 may identify whether each of network addresses related to the set of account information are different from each other. For example, the at least one processor 111 may identify whether the first network address assigned to the first electronic device 310 using the first account information within the set of account information and the second network address assigned to the second electronic device 320 using the second account information within the set of account information are different from each other.

For example, at least one processor 111 may identify that the first network address assigned to the first electronic device 310 and the second network address assigned to the second electronic device 320 are identical, based on values of three groups among the four groups of the first network address excluding a last group assigned to the first electronic device 310 being identical to values of three groups among the four groups of the second network address excluding a last group assigned to the second electronic device 320. As a non-limiting example, in a case that the first network address assigned to the first electronic device 310 is indicated as 115.21.138.174 and the second network address assigned to the second electronic device 320 is indicated as 115.21.138.175, the at least one processor 111 may identify that the first network address assigned to the first electronic device 310 and the second network address assigned to the second electronic device 320 are identical based on the values of the three groups excluding the last group being identical as 115.21.138.

For example, the at least one processor 111 may identify that the first network address assigned to the first electronic device 310 and the second network address assigned to the second electronic device 320 are different, based on the values of the three groups among the four groups of the first network address excluding the last group assigned to the first electronic device 310 being different from the values of the three groups among the four groups of the second network address excluding the last group assigned to the second electronic device 320. As a non-limiting example, in a case that the first network address assigned to the first electronic device 310 is indicated as 115.21.138.174 and the second network address assigned to the second electronic device 320 is indicated as 118.36.68.208, the at least one processor 111 may identify that the first network address assigned to the first electronic device 310 and the second network address assigned to the second electronic device 320 are different based on the values of the three groups excluding the last group being different.

In the operation 430, in a case that the at least one processor 111 identifies that the first network address assigned to the first electronic device 310 and the second network address assigned to the second electronic device 320 are different, operation 440 may be performed. In contrast, in the operation 430, in a case that the at least one processor 111 identifies that the first network address assigned to the first electronic device 310 and the second network address assigned to the second electronic device 320 are identical, the operation 450 may be performed.

In the operation 440, the at least one processor 111 may determine the set of account information used for access to the service as a blacklist for restricting connection to the service. For example, in a case that installation information and a network address related to the software application of each of the first electronic device 310 using the first account information within the set of account information and the second electronic device 320 using the second account information within the set of account information are different, the at least one processor 111 may perform the operation 440. For example, the at least one processor 111 may identify, from the set of account information stored in memory 113 in the server 110, the first account information used by the first electronic device 310 to access the service and the second account information used by the second electronic device 320 to access the service. The at least one processor 111 may determine the identified first account information and the identified second account information as the blacklist for restricting the connection to the service. The at least one processor 111 may store the account information determined as the blacklist in the server 110.

For example, in a case that the first electronic device 310 and the second electronic device 320 including the identical installation information access the service through different network addresses, the at least one processor 111 may identify the access as abnormal access. The at least one processor 111 may generate the blacklist for storing the first account information used by the first electronic device 310 for the abnormal access and the second account information used by the second electronic device 320 for the abnormal access in order to restrict the abnormal access. As a non-limiting example, the at least one processor 111 may further determine, together with the first account information and the second account information used for the abnormal access, the installation information of the software application installed in the first electronic device 310 and the second electronic device 320 as the blacklist for restricting the connection to the service. The at least one processor 111 may further store the installation information in the server 110.

A server used to determine the first account information and the second account information used for the abnormal access as the blacklist may be different from a server used to provide the service. As a non-limiting example, the server for determining the blacklist may be referred to as the server 110 of FIG. 3A. The server used to provide the service may be referred to as the server 120 of FIG. 3A. As a non-limiting example, the blacklist determined to restrict the abnormal access may be stored in a server different from the server 110 and the server 120.

Meanwhile, as a non-limiting example, the server 110 and the server 120 may be a server that is not physically distinguished, and at least one operation disclosed as being performed by the server 110 may be performed by the server 120, and at least one operation disclosed as being performed by the server 120 may be performed by the server 110.

In the operation 450, the at least one processor 111 may refrain from determining the set of account information used for access to the service as the blacklist for restricting access to the service. For example, in a case that the at least one processor 111 identifies that the installation information of the first electronic device 310 using the first account information within the set of account information and the installation information of the second electronic device 320 using the second account information within the set of account information are not duplicated, the operation 450 may be performed. For example, in a case that the at least one processor 111 identifies that network addresses assigned to each of the first electronic device 310 and the second electronic device 320 including the duplicated installation information are different from each other, the operation 450 may be performed.

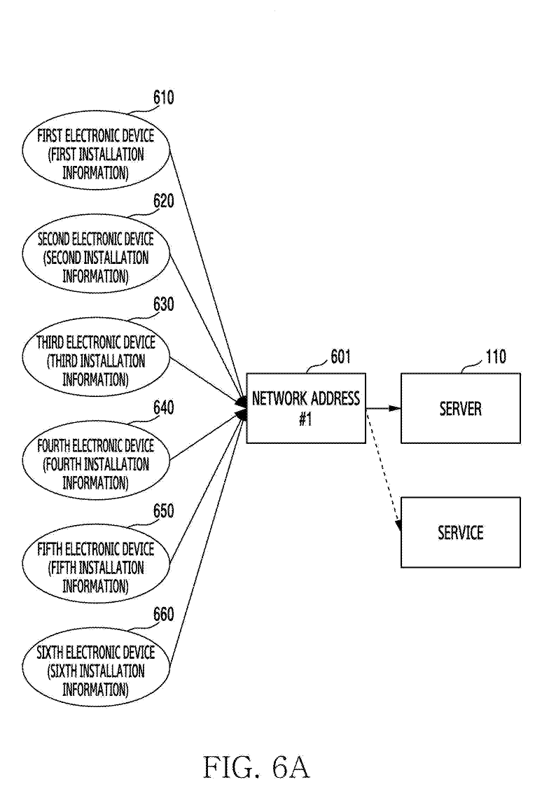

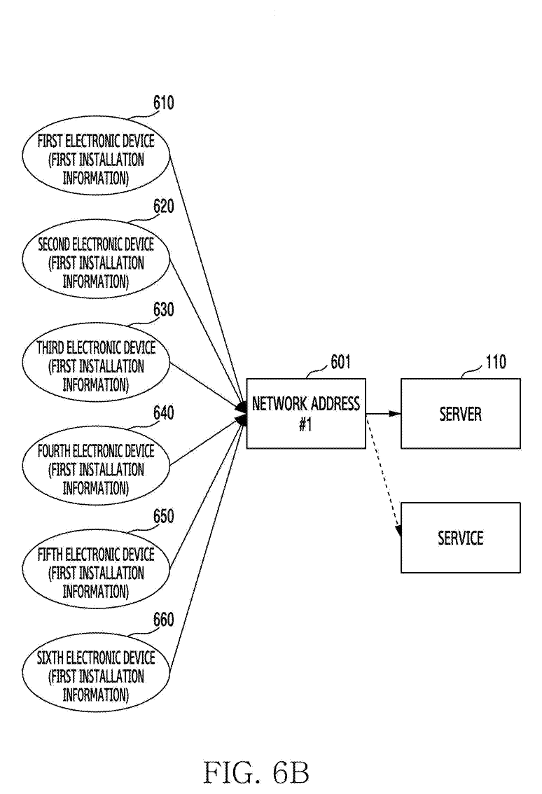

For example, the at least one processor 111 may identify access to the service from each of a plurality of electronic devices (e.g., the first electronic device 310 and the second electronic device 320) as normal access based on installation information of each of the plurality of electronic devices not being duplicated. As a non-limiting example, in a case of a facility (e.g., a PC cafe) for using a public computer, the installation information related to the software application installed in each of the plurality of electronic devices may not be duplicated. For example, in a case that the software application is downloaded to each of the plurality of electronic devices from the platform 399 providing the software application (e.g., the software application 398), the installation information stored (or installed) in each of the plurality of electronic devices may be different from each other. The at least one processor 111 may identify access to the service from each of the plurality of electronic devices in which different installation information is stored as normal access. The at least one processor 111 may refrain from determining account information used for access to the service from each of the plurality of electronic devices as the blacklist for restricting connection to the service based on the identified normal access. The at least one processor 111 may refrain from storing the set of account information in the server 110. A specific example for a case that each of the plurality of electronic devices in which different installation information is stored accesses the server 110 will be described below with reference to FIG. 6A.

As a non-limiting example, in a case of the facility for using the public computer, the installation information stored in each of the plurality of electronic devices (e.g., the first electronic device 310 and the second electronic device 320) may be identical. In a case that the plurality of electronic devices in which the identical installation information is stored access the server 110 through an identical network address, the at least one processor 111 may identify access to the service from the plurality of electronic devices as normal access. As a non-limiting example, in a case that values of three groups excluding a last group of a network address assigned to each of the plurality of electronic devices are identical, the at least one processor 111 may identify that the network address assigned to each of the plurality of electronic devices is identical. The at least one processor 111 may refrain from determining account information used for access to the service from each of the plurality of electronic devices as the blacklist for restricting connection to the service based on the identified normal access. The at least one processor 111 may refrain from storing the account information in the server 110. A specific example for a case that each of the plurality of electronic devices in which the identical installation information is stored accesses the server and/or the service through the identical network address will be described below with reference to FIG. 6B.

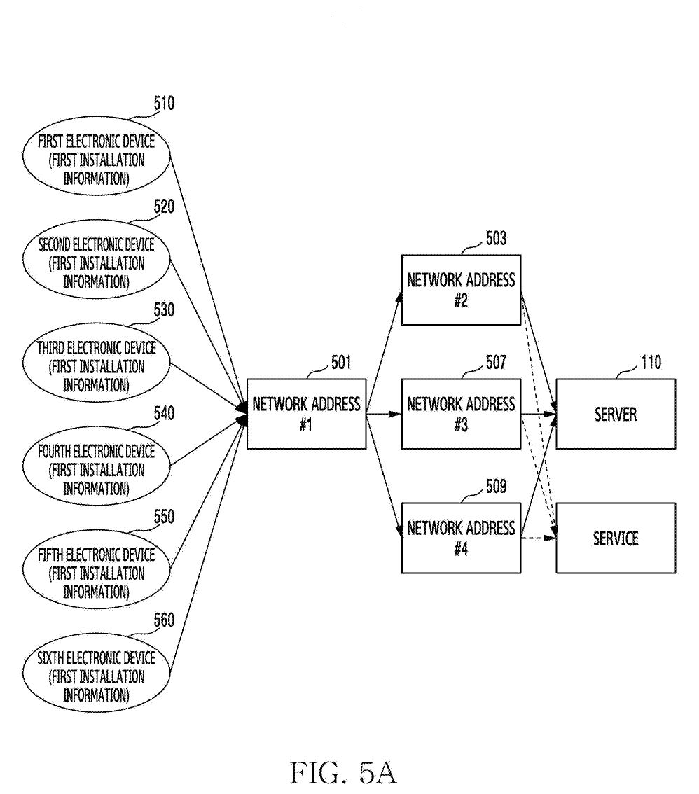

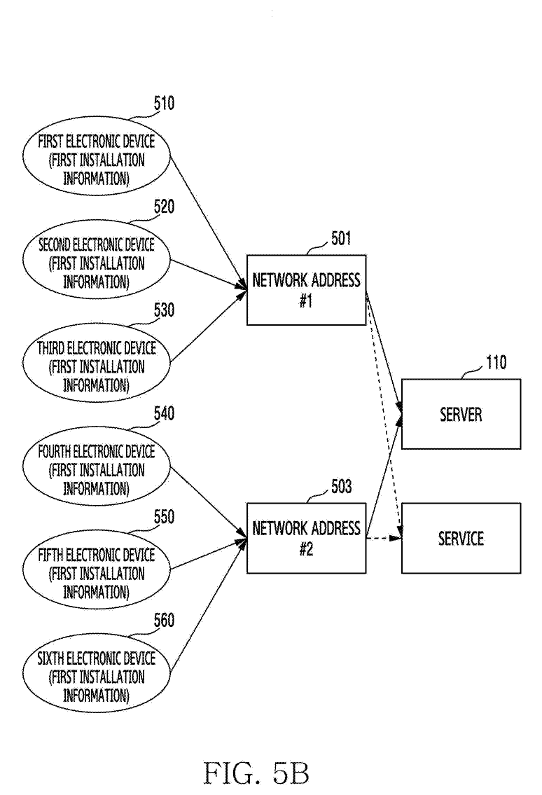

FIGS. 5A and 5B illustrate examples of installation information and network addresses of a plurality of electronic devices in a situation in which the plurality of electronic devices are accessed to a server and a service through a plurality of network addresses.

Referring to FIG. 5A, installation information related to a software application installed in each of a first electronic device 510 to a sixth electronic device 560 may be identical as first installation information. For example, the first installation information granted to the first electronic device 510 when a software application (e.g., the software application 398 of FIG. 3) is installed in the first electronic device 510 may be copied to a second electronic device 520 to the sixth electronic device 560. For example, the software application installed in the first electronic device 510 may be copied to the second electronic device 520 to the sixth electronic device 560. The software application copied to the second electronic device 520 to the sixth electronic device 560 may be stored (or installed) in memory of each of the second electronic device 520 to the sixth electronic device 560. In a case that the software application is copied from the first electronic device 510 to the second electronic device 520 to the sixth electronic device 560, the first installation information included in the software application may also be copied together. The first installation information copied to the second electronic device 520 to the sixth electronic device 560 may be stored (or installed) in the memory of each of the second electronic device 520 to the sixth electronic device 560. As the first installation information is copied, the installation information stored in each of the first electronic device 510 to the sixth electronic device 560 may be identical as the first installation information. As a non-limiting example, although not illustrated in FIG. 5A, in a case that the software application copied from the first electronic device 510 is stored (or installed) in memory of an n-th electronic device, the installation information stored in the n-th electronic device may be identical as the first installation information.

At least one processor 111 of a server 110 may obtain, from each of the first electronic device 510 to the sixth electronic device 560 by using communication circuitry 115, the first installation information stored in each of the first electronic device 510 to the sixth electronic device 560 at a defined time. As a non-limiting example, the at least one processor 111 may obtain the first installation information from each of the first electronic device 510 to the sixth electronic device 560 related to the accounts accessed to the service at a time at which the number of accounts accessed to the service among 24 hours is maximum. As a non-limiting example, the at least one processor 111 may obtain the first installation information from the n-th electronic device related to the accounts accessed to the service at the time at which the number of accounts accessed to the service is maximum. The first electronic device 510 to the sixth electronic device 560 related to the accounts accessed to the service at the defined time may be connected to the server 110 together. For example, in a case that a game application is executed in the first electronic device 510 to the sixth electronic device 560, the first electronic device 510 to the sixth electronic device 560 may be connected to the service and the server 110 together.

The at least one processor 111 may obtain, at the defined time, together with the first installation information, network addresses assigned to each of the first electronic device 510 to the sixth electronic device 560. The at least one processor 111 may identify, at the defined time, together with the installation information and the network addresses, account information used by each of the first electronic device 510 to the sixth electronic device 560 among a set of the account information accessed to the service to access the service. For example, at the defined time, for example, the account information for connecting the service by each of the first electronic device 510 to the sixth electronic device 560 may be first account information to sixth account information, respectively. As a non-limiting example, account information used by the n-th electronic device to connect to the server 110 and the service may be n-th account information.

The at least one processor 111 may identify that the installation information stored in each of the first electronic device 510 to the sixth electronic device 560 is identical as the first installation information. For example, the at least one processor 111 may identify, based on the first installation information of the first electronic device 510, the second electronic device 520 to the sixth electronic device 560 that has transmitted installation information identical to the first installation information. As a non-limiting example, the at least one processor 111 may identify the n-th electronic device that has transmitted installation information identical to the first installation information.

The at least one processor 111 may identify, from the network addresses obtained at the defined time, network addresses assigned to each of the first electronic device 510 to the sixth electronic device 560. For example, at least one processor 111 may identify that the network addresses assigned to each of the first electronic device 510 to the sixth electronic device 560 are identical as a network address #1 501. As a non-limiting example, the network addresses assigned to each of the first electronic device 510 to the sixth electronic device 560 may have values of three groups of the network addresses excluding a last group of each of the first electronic device 510 to the sixth electronic device 560 all identical. As a non-limiting example, a network address of the first electronic device 510 may be indicated as 115.21.138.174. A network address of the second electronic device 520 may be indicated as 115.21.138.175. A network address of a third electronic device 530 may be indicated as 115.21.138.176. A network address of a fourth electronic device 540 may be indicated as 115.21.138.177. A network address of a fifth electronic device 550 may be indicated as 115.21.138.178. A network address of the sixth electronic device 560 may be indicated as 115.21.138.179. As a non-limiting example, although not illustrated in FIG. 5A, a network address assigned to the n-th electronic device may be identical as the network address #1 501 assigned to each of the first electronic device 510 to the sixth electronic device 560. For example, the network address assigned to the n-th electronic device may be indicated as 115.21.138.180.

The network address #1 501 may be changed. As a non-limiting example, the network address #1 501 may be changed to a network address #2 503, a network address #3 507, or a network address #4 509 through a virtual private network (VPN), which is a communication bypass technology. For example, the network address #1 501 of each of the first electronic device 510 and the second electronic device 520 may be changed to the network address #2 503 through the VPN. For example, the network address #1 501 of each of the third electronic device 530 and the fourth electronic device 540 may be changed to the network address #3 507 through the VPN. For example, the network address #1 501 of each of the fifth electronic device 550 and the sixth electronic device 560 may be changed to the network address #4 509 through the VPN. As a non-limiting example, although not illustrated in FIG. 5A, the network address #1 501 of the n-th electronic device may be changed to the network address #2, the network address #3, or the network address #4 through the VPN.

The at least one processor 111 may identify that the network address #2 503, which is the network address of the first electronic device 510 used for access to the service and the network address of the second electronic device 520 used for access to the service, is different from the network address #3 507, which is the network address of the third electronic device 530 used for access to the service and the network address of the fourth electronic device 540 used for access to the service. The at least one processor 111 may identify that access to the service from the first electronic device 510 to the fourth electronic device 540, is abnormal access based on identifying that the network address #2 503 and the network address #3 507 are different.

Based on the identified abnormal access, the at least one processor 111 may determine the first account information used for access to the service from the first electronic device 510 as the blacklist for restricting connection to the service and then store the first account information in the server 110. The at least one processor 111 may determine the second account information used for access to the service from the second electronic device 520 as the blacklist for restricting connection to the service and then store the second account information in the server 110. The at least one processor 111 may determine the third account information used for access to the service from the third electronic device 530 as the blacklist for restricting connection to the service and then store the third account information in the server 110. The at least one processor 111 may determine the fourth account information used for access to the service from the fourth electronic device 540 as the blacklist for restricting connection to the service and then store the fourth account information in the server 110.

The at least one processor 111 may identify that the network address #2 503, which is the network address of the first electronic device 510 and the network address of the second electronic device 520, is different from the network address #4 509, which is the network address of the fifth electronic device 550 and the network address of the sixth electronic device 560. The at least one processor 111 may identify that access to the service from each of the first electronic device 510, the second electronic device 520, the fifth electronic device 550, and the sixth electronic device 560 is abnormal access based on identifying that the network address #2 503 and the network address #4 509 are different.

Based on the identified abnormal access, the at least one processor 111 may determine fifth account information used for access to the service from the fifth electronic device 550 and sixth account information used for access to the service from the sixth electronic device 560 as the blacklist for restricting connection to the service and then store the fifth account information and the sixth account information in the server 110.

The at least one processor 111 may determine the first installation information, the network address #2 503, the network address #3 507, and the network address #4 509 as a blacklist for restricting connection to the service and then store the first installation information, the network address #2 503, the network address #3 507, and the network address #4 509 in the server 110.

Referring to FIG. 5B, the installation information related to the software application installed in each of the first electronic device 510 to the sixth electronic device 560 may all be identical as the first installation information. For example, when the software application is installed in the first electronic device 510, the generated first installation information may be copied to the second electronic device 520 to the sixth electronic device 560. For example, the software application installed in the first electronic device 510 may be copied to the second electronic device 520 to the sixth electronic device 560. The software application copied to the second electronic device 520 to the sixth electronic device 560 may be stored (or installed) in memory of each of the second electronic device 520 to the fourth electronic device 540. In a case that the software application is copied from the first electronic device 510 to the second electronic device 520 to the sixth electronic device 560, the first installation information included in the software application may also be copied together. The first installation information copied to the second electronic device 520 to the sixth electronic device 560 may be stored (or installed) in memory of each of the second electronic device 520 to the sixth electronic device 560. As the first installation information is copied, the installation information stored in each of the first electronic device 510 to the sixth electronic device 560 may all be identical as the first installation information. As a non-limiting example, although not illustrated in FIG. 5B, in a case that the software application copied from the first electronic device 510 is stored (or installed) in the memory of the n-th electronic device, the installation information stored in the n-th electronic device may be identical as the first installation information.

The at least one processor 111 of the server 110 may obtain, from each of the first electronic device 510 to the sixth electronic device 560 by using a communication circuitry 115, the first installation information stored in each of the first electronic device 510 to the sixth electronic device 560 at the defined time. As a non-limiting example, the at least one processor 111 may obtain the first installation information from each of the first electronic device 510 to the sixth electronic device 560 accessed to the service at a time at which the number of accounts accessed to the service among 24 hours is maximum. As a non-limiting example, the at least one processor 111 may obtain the first installation information from the n-th electronic device related to the accounts accessed to the service at the time at which the number of accounts accessed to the service is maximum. The first electronic device 510 to the sixth electronic device 560 related to the accounts accessed to the service at the defined time may be connected to the server 110 together. For example, in a case that the game application is executed in the first electronic device 510 to the sixth electronic device 560, the first electronic device 510 to the sixth electronic device 560 may be connected to the service and the server 110 together.

The at least one processor 111 may obtain, at the defined time, together with the first installation information, network addresses assigned to each of the first electronic device 510 to the sixth electronic device 560. The at least one processor 111 may identify, at the defined time, together with the installation information and the network addresses, account information used by each of the first electronic device 510 to the sixth electronic device 560 to access the service among the set of account information accessed to the service. For example, the at least one processor 111 may identify, at the defined time, among account information stored in the memory 113 of the server 110, the account information used by each of the first electronic device 510 to the sixth electronic device 560 to connect to the service. For example, the account information used by each of the first electronic device 510 to the sixth electronic device 560 to connect to the service may be the first account information to the sixth account information, respectively. As a non-limiting example, although not illustrated in FIG. 5B, account information used by the n-th electronic device to connect to the server 110 and the service may be n-th account information.

The at least one processor 111 may identify that the installation information stored in each of the first electronic device 510 to the sixth electronic device 560 is identical as the first installation information. For example, the at least one processor 111 may identify, based on the first installation information of the first electronic device 510, the second electronic device 520 to the sixth electronic device 560 that has transmitted installation information identical to the first installation information. As a non-limiting example, the at least one processor 111 may identify the n-th electronic device that has transmitted installation information identical to the first installation information.

The at least one processor 111 may identify, from the network address obtained at the defined time, network addresses assigned to each of the first electronic device 510 to the third electronic device 530. For example, the at least one processor 111 may identify that the network addresses assigned to each of the first electronic device 510 to the third electronic device 530 are identical as the network address #1 501. As a non-limiting example, the network addresses assigned to each of the first electronic device 510 to the third electronic device 530 may have values of three groups of the network addresses excluding a last group assigned to each of the first electronic device 510 to the third electronic device 530 all identical. As a non-limiting example, a network address of the first electronic device 510 may be indicated as 115.21.138.174. A network address of the second electronic device 520 may be indicated as 115.21.138.175. A network address of the third electronic device 530 may be indicated as 115.21.138.176. As a non-limiting example, although not illustrated in FIG. 5B, a network address assigned to the n-th electronic device may be identical as the network address #1 501 assigned to each of the first electronic device 510 to the third electronic device 530. For example, the network address assigned to the n-th electronic device may be indicated as 115.21.138.177.

The at least one processor 111 may identify, from the network address obtained at the defined time, network addresses assigned to each of the fourth electronic device 540 to the sixth electronic device 560. For example, the at least one processor 111 may identify that the network addresses assigned to each of the fourth electronic device 540 to the sixth electronic device 560 are identical as the network address #2 503. As a non-limiting example, the network addresses assigned to each of the fourth electronic device 540 to the sixth electronic device 560 may have values of three groups of the network addresses excluding a last group assigned to each of the fourth electronic device 540 to the sixth electronic device 560 all identical. As a non-limiting example, a network address of the fourth electronic device 540 may be indicated as 118.36.68.208. A network address of the fifth electronic device 550 may be indicated as 118.36.68.209. A network address of the sixth electronic device 560 may be indicated as 118.36.68.210. As a non-limiting example, although not illustrated in FIG. 5B, a network address assigned to the n-th electronic device may be identical as the network address #2 503 assigned to each of the fourth electronic device 540 to the sixth electronic device 560. For example, the network address assigned to the n-th electronic device may be indicated as 118.36.68.210.

The at least one processor 111 may identify that the network address #1 501, which is the network address of the first electronic device 510 to the third electronic device 530 used for access to the service, is different from the network address #2 503, which is the network address of the fourth electronic device 540 to the sixth electronic device 560 used for access to the service. The at least one processor 111 may identify that access to the service from the first electronic device 510 to the sixth electronic device 560 is abnormal access based on identifying that the network address #1 501 and the network address #2 503 are different.

Based on the identified abnormal access, the at least one processor 111 may determine the first account information used for access to the service from the first electronic device 510 as the blacklist for restricting connection to the service and then store the first account information in the server 110. The at least one processor 111 may determine the second account information used for access to the service from the second electronic device 520 as the blacklist for restricting connection to the service and then store the second account information in the server 110. The at least one processor 111 may determine the third account information used for access to the service from the third electronic device 530 as the blacklist for restricting connection to the service and then store the third account information in the server 110. The at least one processor 111 may determine the fourth account information used for access to the service from the fourth electronic device 540 as the blacklist for restricting connection to the service and then store the fourth account information in the server 110. The at least one processor 111 may determine the fifth account information used for access to the service from the fifth electronic device 550 as the blacklist for restricting connection to the service and then store the fifth account information in the server 110. The at least one processor 111 may determine the sixth account information used for access to the service from the sixth electronic device 560 as the blacklist for restricting connection to the service and then store the sixth account information in the server 110.

The at least one processor 111 may determine the first installation information, the network address #1 501, and the network address #2 503 as a blacklist for restricting connection to the service and then store the first installation information, the network address #1 501, and the network address #2 503 in the server 110.

FIGS. 6A and 6B illustrate examples of installation information and a network address of a plurality of electronic devices in a situation in which the plurality of electronic devices are accessed to a server and a service through one network address.

Referring to FIG. 6A, installation information stored in a first electronic device 610 may be first installation information. For example, the first installation information may be granted to the first electronic device 610 when the software application is installed in the first electronic device 610. For example, the first installation information may be used to identify the first electronic device 610 by at least one processor 111 of a server 110.

Installation information stored in a second electronic device 620 may be second installation information different from the first installation information. For example, the second installation information may be granted to the second electronic device 620 when the software application is installed in the second electronic device 620. For example, the second installation information may be used to identify the second electronic device 620 by the at least one processor 111 of the server 110.

Installation information stored in a third electronic device 630 may be third installation information different from the first installation information and the second installation information. For example, the third installation information may be granted to the third electronic device 630 when the software application is installed in the third electronic device 630. For example, the third installation information may be used to identify the third electronic device 630 by the at least one processor 111 of the server 110.

Installation information stored in a fourth electronic device 640 may be fourth installation information different from the first installation information to the third installation information. For example, the fourth installation information may be granted to the fourth electronic device 640 when the software application is installed in the fourth electronic device 640. For example, the fourth installation information may be used to identify the fourth electronic device 640 by the at least one processor 111 of the server 110.

Installation information stored in a fifth electronic device 650 may be fifth installation information different from the first installation information to the fourth installation information. For example, the fifth installation information may be granted to the fifth electronic device 650 when the software application is installed in the fifth electronic device 650. For example, the fifth installation information may be used to identify the fifth electronic device 650 by the at least one processor 111 of the server 110.

Installation information stored in a sixth electronic device 660 may be sixth installation information different from the first installation information to the fifth installation information. For example, the sixth installation information may be granted to the sixth electronic device 660 when the software application is installed in the sixth electronic device 660. For example, the sixth installation information may be used to identify the sixth electronic device 660 by the at least one processor 111 of the server 110.

As a non-limiting example, although not illustrated in FIG. 6A, installation information stored in an n-th electronic device may be n-th installation information different from the first installation information to the sixth installation information. For example, the n-th installation information may be granted to the n-th electronic device when the software application is installed in the n-th electronic device. For example, the n-th installation information may be used to identify the n-th electronic device by the at least one processor 111 of the server 110.

The at least one processor 111 of the server 110 may obtain, from each of the first electronic device 610 to the sixth electronic device 660 by using communication circuitry 115, the first installation information to the sixth installation information stored in each of the first electronic device 610 to the sixth electronic device 660 at a defined time. As a non-limiting example, the at least one processor 111 may obtain the first installation information to the sixth installation information from each of the first electronic device 610 to the sixth electronic device 660 related to the accounts accessed to the service at a time at which the number of accounts accessed to the service among 24 hours is maximum. As a non-limiting example, the at least one processor 111 may obtain the n-th installation information from the n-th electronic device related to the accounts accessed to the service at the time at which the number of accounts accessed to the service is maximum. The first electronic device 610 to the sixth electronic device 660 related to the accounts accessed to the service at the defined time may be connected to the server 110 together. For example, when the game application is executed in the first electronic device 610 to the sixth electronic device 660, the first electronic device 610 to the sixth electronic device 660 may access or be connected to the service and the server 110 together.

The at least one processor 111 may obtain, at the defined time, together with the first installation information to the sixth installation information, network addresses assigned to each of the first electronic device 610 to the sixth electronic device 660. The at least one processor 111 may identify, at the defined time, together with the installation information and the network addresses, account information used by each of the first electronic device 610 to the sixth electronic device 660 to access the service. For example, the at least one processor 111 may identify, at the defined time, the account information used by each of the first electronic device 610 to the sixth electronic device 660 to connect to the service, among a set of account information stored in memory 113 of the server 110. For example, the account information for connecting to the service by each of the first electronic device 610 to the sixth electronic device 660 may be first account information to sixth account information, respectively. The at least one processor 111 may identify that the installation information of each of the first electronic device 610 to the sixth electronic device 660 is different from each other. For example, the at least one processor 111 may identify the second electronic device 620 to the sixth electronic device 660 that have transmitted installation information different from the first installation information, based on the first installation information of the first electronic device 610.

For example, the at least one processor 111 may identify that the first installation information of the first electronic device 610 and the second installation information of the second electronic device 620 are different. For example, the at least one processor 111 may identify that the first installation information of the first electronic device 610 and the third installation information of the third electronic device 630 are different. For example, the at least one processor 111 may identify that the first installation information of the first electronic device 610 and the fourth installation information of the fourth electronic device 640 are different. For example, the at least one processor 111 may identify that the first installation information of the first electronic device 610 and the fifth installation information of the fifth electronic device 650 are different. For example, the at least one processor 111 may identify that the first installation information of the first electronic device 610 and the sixth installation information of the sixth electronic device 660 are different.

The at least one processor 111 may, based on identifying that the first installation information to the sixth installation information are different from each other, identify that access to the service from each of the first electronic device 610 to the sixth electronic device 660 is normal access, regardless of whether the network addresses assigned to each of the first electronic device 610 to the sixth electronic device 660 are identical. FIG. 6A illustrates that the network addresses assigned to each of the first electronic device 610 to the sixth electronic device 660 are illustrated as a network address #1 601, but the present disclosure is not limited thereto. As a non-limiting example, the network addresses assigned to each of the first electronic device 610 to the sixth electronic device 660 may be different from each other. As a non-limiting example, the at least one processor 111 may, based on identifying that the n-th installation information of the n-th electronic device is different from the first installation information to the sixth installation information, identify that access to the service from the n-th electronic device is normal access.

Based on identifying the normal access, the at least one processor 111 may refrain from determining the first account information used for access to the service from the first electronic device 610 as a blacklist for restricting connection to the service. The at least one processor 111 may refrain from determining the second account information used for access to the service from the second electronic device 620 as a blacklist for restricting connection to the service. The at least one processor 111 may refrain from determining the third account information used for access to the service from the third electronic device 630 as a blacklist for restricting connection to the service. The at least one processor 111 may refrain from determining the fourth account information used for access to the service from the fourth electronic device 640 as a blacklist for restricting connection to the service. The at least one processor 111 may refrain from determining the fifth account information used for access to the service from the fifth electronic device 650 as a blacklist for restricting connection to the service. The at least one processor 111 may refrain from determining the sixth account information used for access to the service from the sixth electronic device 660 as a blacklist for restricting connection to the service. As a non-limiting example, the at least one processor 111 may refrain from determining the n-th account information used for access to the service from the n-th electronic device as a blacklist for restricting connection to the service.

The at least one processor 111 may refrain from storing the first account information to the sixth account information, the first installation information to the sixth installation information, and the network address #1 601 in the server 110 as a blacklist for restricting connection to the service.

Referring to FIG. 6B, installation information related to a software application installed in each of the first electronic device 610 to the sixth electronic device 660 may be identical as the first installation information. For example, when the software application is installed in the first electronic device 610, the first installation information granted to the first electronic device 610 may be copied to the second electronic device 620 to the sixth electronic device 660. For example, the software application installed in the first electronic device 610 may be copied to the second electronic device 620 to the sixth electronic device 660. The software application copied to the second electronic device 620 to the sixth electronic device 660 may be stored (or, installed) in memory of each of the second electronic device 620 to the sixth electronic device 660. In a case that the software application is copied from the first electronic device 610 to the second electronic device 620 to the sixth electronic device 660, the first installation information included in the software application may also be copied together. The first installation information copied to the second electronic device 620 to the sixth electronic device 660 may be stored (or, installed) in the memory of each of the second electronic device 620 to the sixth electronic device 660. As the first installation information is copied, the installation information stored in each of the first electronic device 610 to the sixth electronic device 660 may be identical as the first installation information. As a non-limiting example, although not illustrated in FIG. 6B, in a case that the software application copied from the first electronic device 610 is stored (or, installed) in memory of the n-th electronic device, the installation information stored in the n-th electronic device may be identical as the first installation information.

The at least one processor 111 of the server 110 may obtain, from each of the first electronic device 610 to the sixth electronic device 660 by using the communication circuitry 115, the first installation information stored in each of the first electronic device 610 to the sixth electronic device 660 at the defined time. As a non-limiting example, the at least one processor 111 may obtain the first installation information from each of the first electronic device 610 to the sixth electronic device 660 related to the accounts accessed to the service at a time at which the number of accounts accessed to the service among 24 hours is maximum. As a non-limiting example, the at least one processor 111 may obtain the n-th installation information from the n-th electronic device related to the accounts accessed to the service at the time at which the number of accounts accessed to the service is maximum. The first electronic device 610 to the sixth electronic device 660 related to the accounts accessed to the service at the defined time may be connected to the server 110 together. For example, in a case that the game application is executed in the first electronic device 610 to the sixth electronic device 660, the first electronic device 610 to the sixth electronic device 660 may access or be connected to the service and the server 110 together.

The at least one processor 111 may obtain, at the defined time, together with the first installation information to the sixth installation information, network addresses assigned to each of the first electronic device 610 to the sixth electronic device 660. The at least one processor 111 may identify, at the defined time, together with the installation information and the network addresses, account information used by each of the first electronic device 610 to the sixth electronic device 660 to access the service, among the set of account information accessed to the service. For example, the at least one processor 111 may identify, at the defined time, the account information used by each of the first electronic device 610 to the sixth electronic device 660 to connect to the service, among account information stored in the memory 113 of the server 110. For example, the account information used by each of the first electronic device 610 to the sixth electronic device 660 to connect to the service may be the first account information to the sixth account information, respectively. As a non-limiting example, account information used by the n-th electronic device to connect to the server 110 and the service may be n-th account information.

The at least one processor 111 may identify that the installation information stored in each of the first electronic device 610 to the sixth electronic device 660 is identical as the first installation information. For example, the at least one processor 111 may identify the second electronic device 620 to the sixth electronic device 660 that have transmitted installation information identical to the first installation information, based on the first installation information of the first electronic device 610. As a non-limiting example, the at least one processor 111 may identify the n-th electronic device that has transmitted installation information identical to the first installation information.

The at least one processor 111 may identify the network addresses assigned to each of the first electronic device 610 to the sixth electronic device 660 from the network address obtained at the defined time. For example, the at least one processor 111 may identify that the network addresses assigned to each of the first electronic device 610 to the sixth electronic device 660 are identical as the network address #1 601. Based on identifying the identicalness, the at least one processor 111 may identify that access to the service from each of the first electronic device 610 to the sixth electronic device 660 is normal access.

Based on the identified normal access, the at least one processor 111 may refrain from determining the first account information used for access to the service from the first electronic device 610 as the blacklist for restricting connection to the service. The at least one processor 111 may refrain from determining the second account information used for access to the service from the second electronic device 620 as the blacklist for restricting connection to the service. The at least one processor 111 may refrain from determining the third account information used for access to the service from the third electronic device 630 as the blacklist for restricting connection to the service. The at least one processor 111 may refrain from determining the fourth account information used for access to the service from the fourth electronic device 640 as the blacklist for restricting connection to the service. The at least one processor 111 may refrain from determining the fifth account information used for access to the service from the fifth electronic device 650 as the blacklist for restricting connection to the service. The at least one processor 111 may refrain from determining the sixth account information used for access to the service from the sixth electronic device 660 as the blacklist for restricting connection to the service. As a non-limiting example, the at least one processor 111 may refrain from determining the n-th account information used for access to the service from the n-th electronic device as the blacklist for restricting connection to the service.

The at least one processor 111 may refrain from storing the first account information to the sixth account information, the first installation information, and the network address #1 501 in the server 110 as the blacklist for restricting connection to the service.

As described above with reference to FIG. 6A, in a case that different installation information is stored in the plurality of electronic devices, the at least one processor 111 may identify access to the service from each of the plurality of electronic devices as normal access. As described above with reference to FIG. 6B, in a case that the network addresses assigned to the plurality of electronic devices in which identical installation information is stored are identical, the at least one processor 111 may identify access to the service from each of the plurality of electronic devices as normal access. The cases described above with reference to FIGS. 6A and 6B may be an example of a case that the service is accessed by using the plurality of electronic devices in a facility (e.g., a PC cafe) for using a public computer. The at least one processor 111 may identify access to the service by using the plurality of electronic devices in the facility for using the public computer as normal access.

As a non-limiting example, the at least one processor 111 may identify a set of account information accessed to the service. The at least one processor 111 may exclude, from a target for identifying whether there is abnormal access to the service, a set of account information related to the facility for using the public computer among the set of account information accessed to the service. For example, the set of account information related to the facility for using the public computer may be stored (or, registered) in the memory 113 in the server 110. For example, the at least one processor 111 may, from a remaining set of account information excluding the set of account information related to the facility for using the public computer among the set of account information accessed to the service at the defined time, identify account information used for the abnormal access. For example, as in FIGS. 6A and 6B, in a case that the set of account information related to the facility for using the public computer includes the first account information to the sixth account information, the at least one processor 111 may exclude the first account information to the sixth account information from the target for identifying whether there is the abnormal access.

As a non-limiting example, the at least one processor 111 may further exclude installation information and network addresses related to the set of account information of the facility for using the public computer from the target for identifying whether there is the abnormal access to the service.

For example, the at least one processor 111 may further exclude installation information of each of the plurality of electronic devices of the facility for using the public computer from the target for identifying whether there is the abnormal access to the service. For example, as in FIG. 6B, in a case that installation information of each of the first electronic device 610 to the sixth electronic device 660 of the facility for using the public computer is the first installation information, the at least one processor 111 may further exclude the first installation information from the target for identifying whether there is the abnormal access to the service. The installation information of each of the plurality of electronic devices of the facility for using the public computer may be further stored (or, registered) in the memory 113 in the server 110.

For example, the at least one processor 111 may further exclude the network addresses assigned to each of the plurality of electronic devices of the facility for using the public computer from the target for identifying whether there is the abnormal access to the service. For example, as in FIG. 6B, in a case that the network addresses assigned to each of the first electronic device 610 to the sixth electronic device 660 of the facility for using the public computer are the network address #1 601, the at least one processor 111 may further exclude the network address #1 601 from the target for identifying whether there is the abnormal access to the service. The network addresses assigned to each of the plurality of electronic devices of the facility for using the public computer may be further stored (or, registered) in the memory 113 in the server 110.

After excluding the set of account information related to the facility for using public computers, the installation information, and the network addresses from the target for identifying whether there is the abnormal access to the service ,the at least one processor 111 may identify the set of account information, the installation information, and the network addresses used for the abnormal access to the service.

For example, referring to FIG. 6B, the at least one processor 111 may identify the first installation information related to the first account information accessed to the service at the defined time. The at least one processor 111 may identify the second account information to the sixth account information accessed to the service by using the first installation information among the set of account information accessed to the service at the defined time. The at least one processor 111 may identify the first electronic device 610 to the sixth electronic device 660 that have accessed to the service by using the first account information to the sixth account information.

The at least one processor 111 may identify that network addresses assigned to each of the first electronic device 610 to the sixth electronic device 660 are identical as the network address #1 601. The at least one processor 111 may identify that the network address #1 601 is a network address related to the facility for using the public computer. For example, the at least one processor 111 may identify that the network address #1 601 is included in a list of network addresses further stored (or, registered) in the memory 113 in the server 110 to identify that the network address #1 601 is the facility for using the public computer. Based on identifying that network address #1 601 is included in the list, the at least one processor 111 may exclude the first account information to the sixth account information, the first installation information, and the network address #1 601 from the target for identifying whether there is the abnormal access to the service.

The at least one processor 111 may identify whether access to the service is abnormal access by using account information excluding the first account information to the sixth account information among the set of account information. For example, the at least one processor 111 may identify seventh account information included in the set of account information. The at least one processor 111 may identify installation information related to the seventh account information. The at least one processor 111 may identify eighth account information using installation information identical to the installation information related to the seventh account information.

The at least one processor 111 may identify a seventh electronic device accessed to the service by using the seventh account information and an eighth electronic device accessed to the service by using the eighth account information. The at least one processor 111 may identify a network address #7 assigned to the seventh electronic device and a network address #8 assigned to the eighth electronic device. The at least one processor 111 may identify whether the network address #7 is different from the network address #8.

In a case that the at least one processor 111 identifies that the network address #7 is different from the network address #8, the at least one processor 111 may identify that access to the service by using the seventh account information and the eighth account information is the abnormal access. The at least one processor 111 may determine the seventh account information, the eighth account information, the installation information related to the seventh account information, the network address #7, and the network address #8 as a blacklist for restricting access to the service.

FIG. 7 illustrates a graph indicating the number of accounts accessed to a service over time.

Referring to FIG. 7, a horizontal axis of a graph 700 indicates time (unit: hour), and a vertical axis of the graph 700 indicates the number of accounts accessed to the service.

A line 701 in the graph 700 indicates the number of accounts accessed to the service over time. For example, the line 701 may indicate the number of the accounts accessed to the service for 24 hours. As a non-limiting example, the line 701 may indicate the number of the accounts accessed to the service from 6 a.m. to 6 a.m. of the next day that is 24 hours later.

A time 703 may indicate a time at which the number of accounts accessed to the service is maximum among a designated time. As a non-limiting example, the designated time may include 24 hours (or, one day). For example, the time 703 may indicate a time at which the number of accounts accessed to the service is maximum among the 24 hours. The time 703 may be referred to as a defined time (e.g., the defined time of FIG. 4).

At least one processor 111 of a server 110 may obtain, at the defined time, by using communication circuitry 115, from each of a plurality of electronic devices (e.g., the first electronic device 510 to the sixth electronic device 560 of FIGS. 5A and 5B or the first electronic device 610 to the sixth electronic device 660 of FIGS. 6A and 6B) using accounts accessed to the service, each installation information (e.g., installation information 397) related to a software application (e.g., a software application 398) installed in each of the plurality of electronic devices. The at least one processor 111 may obtain, together with the installation information, network addresses assigned to each of the plurality of electronic devices. The at least one processor 111 may identify, based on the obtained installation information and the network address, whether an access to the service from the plurality of electronic devices is abnormal access.

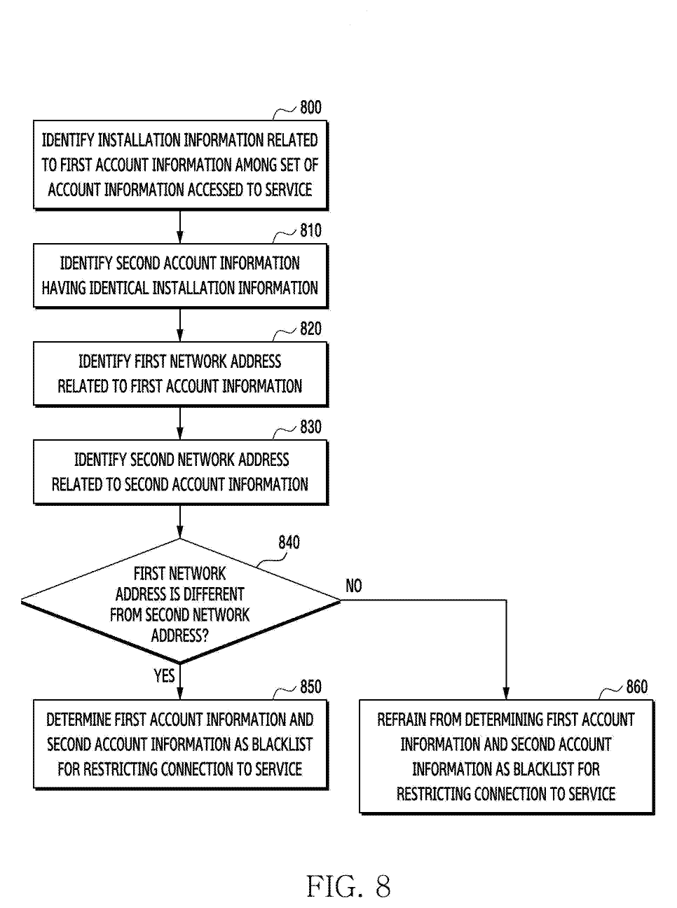

FIG. 8 is a flowchart illustrating an operation of a server determining account information as a blacklist based on installation information and a network address related to the account information.

At least a portion of the method of FIG. 8 may be performed by the server 110 of FIG. 3A. For example, at least a portion of the method may be controlled by at least one processor 111 of the server 110. In the following embodiment, each operation may be sequentially performed, but is not necessarily performed sequentially. For example, an order of each operation may be changed, and at least two operations may be performed in parallel.

In operation 800, the at least one processor 111 may identify installation information related to first account information among a set of account information accessed to a service. For example, the service may be substantially identical to the service of FIG. 3A. The set of account information may include the first account information used by a first electronic device 310 among a plurality of electronic devices (e.g., the first electronic device 310 and a second electronic device 320) to access the service and second account information used by the second electronic device 320 to access the service.

The at least one processor 111 may obtain installation information (e.g., installation information 397) of each of the plurality of electronic devices using the set of account information connected to the service. For example, each of the plurality of electronic devices may use a software application (e.g., a software application 398) installed (or, stored) in each of the plurality of electronic devices for access to the service. For example, each of the plurality of electronic devices may execute a game application (e.g., the game application of FIG. 3A) through the software application installed in each of the plurality of electronic devices. The at least one processor 111 may obtain installation information included in the software application installed in each of the plurality of electronic devices.

The installation information related to the first account information may indicate the installation information included in the software application installed in the first electronic device 310. For example, the first electronic device 310 may execute the game application by using the software application installed in the first electronic device 310. The first electronic device 310 may access the service by using the first account information. The at least one processor 111 may identify the installation information related to the first account information by identifying the installation information included in the software application installed in the first electronic device 310.

For example, the at least one processor 111 may obtain installation information included in the software application installed in each of the plurality of electronic devices accessed to the service at a defined time. For example, the defined time may include a time at which the number of accounts accessed to the service is maximum among a designated time. As a non-limiting example, the designated time may include 24 hours (or, one day). For example, at least one processor 111 may identify the number of accounts used by each of the plurality of electronic devices accessed to the service to access the service. The designated time may include a time at which the number of the plurality of electronic devices accessed to the service by using the accounts is maximum.

In operation 810, the at least one processor 111 may identify second account information having installation information identical to the installation information among the set of account information.

For example, the installation information related to the second account information may indicate the installation information included in the software application installed in the second electronic device 320. For example, the second electronic device 320 may execute the game application by using the software application installed in the second electronic device 320. The second electronic device 320 may access the service by using the second account information. The at least one processor 111 may identify the installation information related to the second account information by identifying the installation information included in the software application installed in the second electronic device 320.

For example, the at least one processor 111 may identify the second electronic device 320 that has transmitted the installation information identical to the installation information obtained from the first electronic device 310 by using (or, based on) the installation information obtained from the first electronic device 310. As a non-limiting example, in a case that the at least one processor 111 obtains identical installation information from the first electronic device 310 and the second electronic device 320 by using communication circuitry 115, the at least one processor 111 may identify the second electronic device 320 that has transmitted the installation information identical to the installation information obtained from the first electronic device 310, based on the installation information obtained from the first electronic device 310. The at least one processor 111 may identify the second account information used by the second electronic device 320 that has transmitted the identical installation information among the set of account information to access the service.

In operation 820, the at least one processor 111 may identify a first network address related to the first account information. For example, the at least one processor 111 may obtain the network address related to the set of account information accessed to the service at the defined time. For example, the at least one processor 111 may identify, from the obtained network address, network addresses assigned to each of the plurality of electronic devices using account information in the set of account information. For example, the at least one processor 111 may identify the first network address related to the first account information in the set of account information. For example, the at least one processor 111 may identify a network address assigned to the first electronic device 310 accessed to the service by using the first account information. For example, the at least one processor 111 may identify the first network address assigned to the first electronic device 310 from the network address obtained at the defined time.

In operation 830, the at least one processor 111 may identify a second network address related to the second account information. For example, the at least one processor 111 may obtain the network address related to the set of account information accessed to the service at the defined time. For example, the at least one processor 111 may identify, from the obtained network address, network addresses assigned to each of the plurality of electronic devices using account information in the set of account information. For example, the at least one processor 111 may identify the second network address related to the second account information in the set of account information. For example, the at least one processor 111 may identify a network address assigned to a second electronic device 320 accessed to the service by using the second account information. For example, the at least one processor 111 may identify the second network address assigned to the second electronic device 320 from the network address obtained at the defined time.

In operation 840, the at least one processor 111 may identify whether the first network address is different from the second network address. For example, the at least one processor 111 may identify whether the first network address related to the first account information is different from the second network address related to the second account information. For example, the at least one processor 111 may identify whether a network address assigned to the first electronic device 310 accessed to the service by using the first account information is different from a network address assigned to the second electronic device 320 accessed to the service by using the second account information.

For example, the at least one processor 111 may identify that the first network address assigned to the first electronic device 310 and the network address assigned to the second electronic device 320 are identical, based on values of three groups among four groups of the first network address excluding a last group assigned to the first electronic device 310 being identical to values of three groups among four groups of the second network address excluding a last group assigned to the second electronic device 320. As a non-limiting example, in a case that the first network address assigned to the first electronic device 310 is indicated as 115.21.138.174 and the network address assigned to the second electronic device 320 is indicated as 115.21.138.175, the at least one processor 111 may identify that the first network address assigned to the first electronic device 310 and the second network address assigned to the second electronic device 320 are identical, based on that values of three groups excluding the last group are identical as 115.21.138.

For example, the at least one processor 111 may identify that the first network address assigned to the first electronic device 310 and the second network address assigned to the second electronic device 320 are different, based on that the values of the three groups among the four groups of the first network address excluding the last group assigned to the first electronic device 310 are different from the values of the three groups among the four groups of the network address excluding the last group assigned to the second electronic device 320. As a non-limiting example, in a case that the first network address assigned to the first electronic device 310 is indicated as 115.21.138.174 and the second network address assigned to the second electronic device 320 is indicated as 118.36.68.208, the at least one processor 111 may identify that the first network address assigned to the first electronic device 310 and the second network address assigned to the second electronic device 320 are different, based on that the values of the three groups excluding the last group are different.

In the operation 840, in a case that the at least one processor 111 identifies that the first network address assigned to the first electronic device 310 and the second network address assigned to the second electronic device 320 are different, the at least one processor 111 may perform operation 850. In contrast, in the operation 840, in a case that the at least one processor 111 identifies that the first network address assigned to the first electronic device 310 and the second network address assigned to the second electronic device 320 are identical, the at least one processor 111 may perform operation 860.

In the operation 850, the at least one processor 111 may determine the first account information and the second account information as a blacklist for restricting connection to the service. For example, the at least one processor 111 may determine the first account information and the second account information as the blacklist for restricting access to the service, based on identifying that the first network address is different from the second network address. For example, the at least one processor 111 may identify the first account information and the second account information used by each of the first electronic device 310 and the second electronic device 320 to access the server 110 from account information stored in memory 113. The at least one processor 111 may determine the identified first account information and the identified second account information as the blacklist for restricting connection to the service. For example, the at least one processor 111 may store the first account information and the second account information in the server 110 after determining the first account information and the second account information as the blacklist for restricting connection to the service.

For example, the at least one processor 111 may identify the access as abnormal access, in a case that the first electronic device 310 and the second electronic device 320 in which identical installation information is stored access the server 110 through different network addresses, respectively. The at least one processor 111 may generate the blacklist for storing the first account information used in the first electronic device 310 for the abnormal access and the second account information used in the second electronic device 320 for the abnormal access, in order to restrict the abnormal access. As a non-limiting example, the at least one processor 111 may further determine, as the blacklist for restricting connection to the service, the installation information related to the software application installed in the first electronic device 310 and the second electronic device 320, the first network address assigned to the first electronic device 310, and the second network address assigned to the second electronic device 320, together with the first account information and the second account information used for the abnormal access.

In the operation 860, the at least one processor 111 may refrain from determining the first account information and the second account information as the blacklist for restricting connection to the service. For example, the at least one processor 111 may refrain from determining the first account information and the second account information used by each of the first electronic device 310 and the second electronic device 320 to access the server 110 as the blacklist for restricting connection to the service.

For example, the at least one processor 111 may identify the access as normal access, in a case that the first electronic device 310 and the second electronic device 320 in which the identical installation information is stored access the server 110 through an identical network address. Based on the identified normal access, the at least one processor 111 may refrain from determining the first account information used in the first electronic device 310 for access to the service as the blacklist for restricting connection to the service. The at least one processor 111 may refrain from determining the second account information used in the second electronic device 320 for access to the service as the blacklist for restricting connection to the service. For example, the at least one processor 111 may determine the first account information or the second account information, the first installation information, the first network address, and the second network address as the blacklist restricting connection to the service, and then refrain from storing them in the memory 113 in the server 110.

As described above, a server (e.g., the server 119) may comprise communication circuitry (e.g., the communication circuitry 115). The server may comprise memory (e.g., the memory 113) comprising one or more storage media storing instructions. The server may comprise at least one processor (e.g., the at least one processor 111) comprising processing circuitry. The instructions, when executed by the at least one processor individually or collectively, may cause the server to identify installation information related to first account information among a set of account information accessed to a service. The instructions, when executed by the at least one processor individually or collectively, may cause the server to identify, among the set of account information, second account information having the same installation information as the installation information related to the first account information. The instructions, when executed by the at least one processor individually or collectively, may cause the server to identify a first network address related to the first account information and a second network address related to the second account information. The instructions, when executed by the at least one processor individually or collectively, may cause the server to, based on identifying that the first network address and the second network address are different, determine the first account information and the second account information as a blacklist for restricting access to the service.

According to an embodiment, the instructions, when executed by the at least one processor individually or collectively, may cause the server to further determine the installation information related to the software application as the blacklist for restricting the access to the service.

According to an embodiment, the installation information may be granted to a first electronic device in a case that a software application is installed in the first electronic device using the first account information. The installation information may be granted to a second electronic device in a case that the software application is installed in the second electronic device using the second account information.

According to an embodiment, the instructions, when executed by the at least one processor individually or collectively, may cause the server to obtain, from each of a plurality of electronic devices during a defined time interval, each installation information related to the software application installed in the plurality of electronic devices by using the communication circuitry.

According to an embodiment, the defined time interval may include, among a designated time interval, a time at which the number of accounts accessed to the service is maximum.

According to an embodiment, the instructions, when executed by the at least one processor individually or collectively, may cause the server to, based on first authentication information received from the first electronic device for access from the first electronic device to the service, identify the first account information by using the communication circuitry. The instructions, when executed by the at least one processor individually or collectively, may cause the server to, based on second authentication information received from the second electronic device for access from the second electronic device to the service, identify the second account information by using the communication circuitry.

According to an embodiment, each of the first authentication information and the second authentication information may include a user identifier and a password for authentication performed in a software application.

According to an embodiment, the first account information may be linked with the first authentication information and may be used for access to the service which provides a game application executed via the software application. The second account information may be linked with the second authentication information and may be used for access to the service which provides the game application executed via the software application.

According to an embodiment, each of the first network address and the second network address may include an internet protocol (IP) address defined by four groups. Each of the four groups may comprise a designated range.

According to an embodiment, the instructions, when executed by the at least one processor individually or collectively, may cause the server to, based on values of three groups among the four groups of the first network address excluding a last group of the first network address being identical with values of three groups among the four groups of the second network address excluding a last group of the second network address, identify that the first network address and the second network address are identical. The instructions, when executed by the at least one processor individually or collectively, may cause the server to, based on the values of the three groups of the first network address being different from the values of the three groups of the second network address, identify that the first network address and the second network address are different.

According to an embodiment, the instructions, when executed by the at least one processor individually or collectively, may cause the server to, based on second installation information different from the installation information, refrain from determining third account information used for access from a third electronic device having the second installation information to the service as the blacklist.

According to an embodiment, the instructions, when executed by the at least one processor individually or collectively, may cause the server to, based on identifying that the first network address and the second network address are identical, refrain from determining the first account information and the second account information as the blacklist.

As described above, a method performed by a server comprising communication circuitry may comprise identifying installation information related to first account information among a set of account information accessed to a service. The method may comprise identifying, among the set of account information, second account information having the same installation information as the installation information related to the first account information. The method may comprise identifying a first network address related to the first account information and a second network address related to the second account information. The method may comprise, based on identifying that the first network address and the second network address are different, determining the first account information and the second account information as a blacklist for restricting access to the service.

According to an embodiment, the method may comprise further determining the installation information as the blacklist for restricting the access to the service.

According to an embodiment, the installation information may be granted to a first electronic device in a case that a software application is installed in the first electronic device using the first account information. The installation information may be granted to a second electronic device in a case that the software application is installed in the second electronic device using the second account information.

According to an embodiment, the method may comprise obtaining, from each of a plurality of electronic devices during a defined time interval, each installation information related to the software application installed in the plurality of electronic devices by using the communication circuitry.

According to an embodiment, the defined time interval may include, among a designated time interval, a time at which the number of accounts accessed to the service is maximum.

According to an embodiment, the method may comprise, based on first authentication information received from the first electronic device for access from the first electronic device to the service, identifying the first account information by using the communication circuitry. The method may comprise, based on second authentication information received from the second electronic device for access from the second electronic device to the service, identifying the second account information by using the communication circuitry.

According to an embodiment, each of the first authentication information and the second authentication information may include a user identifier and a password for authentication performed in a software application.

As described above, a non-transitory computer-readable storage medium, when executed by a server comprising communication circuitry, may store one or more programs including instructions that cause the server to identify installation information related to first account information among a set of account information accessed to a service. The non-transitory computer-readable storage medium, when executed by the server, may store one or more programs including instructions that cause the server to identify, among the set of account information, second account information having the same installation information as the installation information related to the first account information. The non-transitory computer-readable storage medium, when executed by the server, may store one or more programs including instructions that cause the server to identify a first network address related to the first account information and a second network address related to the second account information. The non-transitory computer-readable storage medium, when executed by the server, may store one or more programs including instructions that cause the server to, based on identifying that the first network address and the second network address are different, determine the first account information and the second account information as a blacklist for restricting access to the service.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A server comprising:
communication circuitry;
memory comprising one or more storage media storing instructions; and
at least one processor comprising processing circuitry,
wherein the instructions, when executed by the at least one processor individually or collectively, cause the server to:
identify installation information related to first account information among a set of account information accessed to a service,
identify, among the set of account information, second account information having the same installation information as the installation information related to the first account information;
identify a first network address related to the first account information and a second network address related to the second account information; and
based on identifying that the first network address and the second network address are different, determine the first account information and the second account information as a blacklist for restricting access to the service.

2. The server of claim 1,
wherein the instructions, when executed by the at least one processor individually or collectively, cause the server to:
further determine the installation information as the blacklist for restricting the access to the service.

3. The server of claim 1,
wherein the installation information is granted to a first electronic device in a case that a software application is installed in the first electronic device using the first account information, and
wherein the installation information is granted to a second electronic device in a case that the software application is installed in the second electronic device using the second account information.

4. The server of claim 1,
wherein the instructions, when executed by the at least one processor individually or collectively, cause the server to:
obtain, from each of a plurality of electronic devices during a defined time interval, each installation information related to the software application installed in the plurality of electronic devices by using the communication circuitry.

5. The server of claim 4,
wherein the defined time interval includes, among a designated time interval, a time at which the number of accounts accessed to the service is maximum.

6. The server of claim 1,
wherein the instructions, when executed by the at least one processor individually or collectively, cause the server to:
based on first authentication information received from the first electronic device for access from the first electronic device to the service, identify the first account information by using the communication circuitry; and
based on second authentication information received from the second electronic device for access from the second electronic device to the service, identify the second account information by using the communication circuitry.

7. The server of claim 6,
wherein each of the first authentication information and the second authentication information includes a user identifier and a password for authentication performed in a software application.

8. The server of claim 7,
wherein the first account information is linked with the first authentication information and used for access to the service which provides a game application executed via the software application, and
wherein the second account information is linked with the second authentication information and used for access to the service which provides the game application executed via the software application.

9. The server of claim 1,
wherein each of the first network address and the second network address includes an internet protocol (IP) address defined by four groups, and
wherein each of the four groups comprises a designated range.

10. The server of claim 9,
wherein the instructions, when executed by the at least one processor individually or collectively, cause the server to:
based on values of three groups among the four groups of the first network address excluding a last group of the first network address being identical with values of three groups among the four groups of the second network address excluding a last group of the second network address, identify that the first network address and the second network address are identical; and
based on the values of the three groups of the first network address being different from the values of the three groups of the second network address, identify that the first network address and the second network address are different.

11. The server of claim 1,
wherein the instructions, when executed by the at least one processor individually or collectively, cause the server to:
based on second installation information different from the installation information, refrain from determining third account information used for access from a third electronic device having the second installation information to the service as the blacklist.

12. The server of claim 1,
wherein the instructions, when executed by the at least one processor individually or collectively, cause the server to:
based on identifying that the first network address and the second network address are identical, refrain from determining the first account information and the second account information as the blacklist.

13. A method performed by a server comprising communication circuitry comprising:
identifying installation information related to first account information among a set of account information accessed to a service,
identifying, among the set of account information, second account information having the same installation information as the installation information related to the first account information;
identifying a first network address related to the first account information and a second network address related to the second account information; and
based on identifying that the first network address and the second network address are different, determining the first account information and the second account information as a blacklist for restricting access to the service.

14. The method of claim 13, comprising:
further determining the installation information as the blacklist for restricting the access to the service.

15. The method of claim 13,
wherein the installation information is granted to a first electronic device in a case that a software application is installed in the first electronic device using the first account information, and
wherein the installation information is granted to a second electronic device in a case that the software application is installed in the second electronic device using the second account information.

16. The method of claim 13, comprising:
obtaining, from each of a plurality of electronic devices during a defined time interval, each installation information related to the software application installed in the plurality of electronic devices by using the communication circuitry.

17. The method of claim 13,
wherein the defined time interval includes, among a designated time interval, a time at which the number of accounts accessed to the service is maximum.

18. The method of claim 13, comprising:
based on first authentication information received from the first electronic device for access from the first electronic device to the service, identifying the first account information by using the communication circuitry; and
based on second authentication information received from the second electronic device for access from the second electronic device to the service, identifying the second account information by using the communication circuitry.

19. The method of claim 18,
wherein each of the first authentication information and the second authentication information includes a user identifier and a password for authentication performed in a software application.

20. A non-transitory computer-readable storage medium, when executed by a server comprising communication circuitry, storing one or more programs including instructions that cause the server to:
identify installation information related to first account information among a set of account information accessed to a service,
identify, among the set of account information, second account information having the same installation information as the installation information related to the first account information;
identify a first network address related to the first account information and a second network address related to the second account information; and
based on identifying that the first network address and the second network address are different, determine the first account information and the second account information as a blacklist for restricting access to the service.
